(19) United States
(12) Patent Application Publication
(10) Pub. No.: US 2025/0150296 A1
(43) Pub. Date: May 8, 2025

(54) CONFERENCE CALL SYSTEM WITH FEEDBACK

(71) Applicant: Intel Corporation, Santa Clara, CA (US)

(72) Inventors: Venkat Raghavulu, Bangalore (IN); Ke Han, Shanghai (CN); Sean Jude William Lawrence, Bangalore (IN)

(21) Appl. No.: 18/838,905

(22) PCT Filed: Mar. 30, 2022
(86) PCT No.: PCT/CN2022/083905

§ 371 Date: Aug. 15, 2024

(51) Int. Cl. H04L 12/18; G06F 3/16

(52) U.S. Cl. CPC H04L 12/1895; G06F 3/165

(57) ABSTRACT

Particular embodiments described herein provide for an electronic device that is configured to receive audio data related to a conference call from a network conference engine, sample the audio data at a frame rate, determine an amount of missing samples of audio data for a predetermined amount of time, and communicate, to the network conference engine, a notification when the amount of missing samples of audio data for the predetermined amount of time is greater than a lost sample threshold. The electronic device can also be configured to receive visual content and visual content verification data from the network conference engine and use the visual content verification data to determine if visual content to be rendered on a display of the electronic device is the same or similar to the received visual content from the network conference engine.

### TECHNICAL FIELD

This disclosure relates in general to the field of computing, and more particularly, to a conference call system with feedback.

### BACKGROUND

End users have more electronic device choices than ever before. A number of prominent technological trends are currently afoot and these trends are changing the electronic device landscape. Some of the technological trends involve a conference call system where users can remotely connect to each other over a network without having to be physically in the same room.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a system to enable a conference call system with feedback, in accordance with an embodiment of the present disclosure;

FIG. 1B is a simplified block diagram of a system to enable a conference call system with feedback, in accordance with an embodiment of the present disclosure;

FIG. 1C is a simplified block diagram of a system to enable a conference call system with feedback, in accordance with an embodiment of the present disclosure;

FIG. 2A is a simplified block diagram illustrating example details of a portion of a system to enable a conference call system with feedback, in accordance with an embodiment of the present disclosure;

FIG. 2B is a simplified block diagram illustrating example details of a portion of a system to enable a conference call system with feedback, in accordance with an embodiment of the present disclosure;

FIG. 2C is a simplified block diagram illustrating example details of a portion of a system to enable a conference call system with feedback, in accordance with an embodiment of the present disclosure;

FIG. 2D is a simplified block diagram illustrating example details of a portion of a system to enable a conference call system with feedback, in accordance with an embodiment of the present disclosure;

FIG. 3 is a simplified block diagram illustrating example details of a portion of a system to enable a conference call system with feedback, in accordance with an embodiment of the present disclosure;

FIG. 4 is a simplified block diagram illustrating example details of a portion of a system to enable a conference call system with feedback, in accordance with an embodiment of the present disclosure;

FIG. 5 is a simplified block diagram illustrating example details of a system to enable a conference call system with feedback, in accordance with an embodiment of the present disclosure;

FIG. 6 is a simplified block diagram of a lookup table illustrating example details of a system to enable a conference call system with feedback, in accordance with an embodiment of the present disclosure;

FIG. 7 is a simplified block diagram illustrating example details of a system to enable a conference call system with feedback, in accordance with an embodiment of the present disclosure;

FIG. 8 is a simplified flowchart illustrating potential operations that may be associated with the system in accordance with an embodiment of the present disclosure;

FIG. 9 is a simplified flowchart illustrating potential operations that may be associated with the system in accordance with an embodiment of the present disclosure;

FIG. 10 is a simplified flowchart illustrating potential operations that may be associated with the system in accordance with an embodiment of the present disclosure;

FIG. 11 is a simplified flowchart illustrating potential operations that may be associated with the system in accordance with an embodiment of the present disclosure; and

FIG. 12 is a simplified flowchart illustrating potential operations that may be associated with the system in accordance with an embodiment of the present disclosure.

The FIGURES of the drawings are not necessarily drawn to scale, as their dimensions can be varied considerably without departing from the scope of the present disclosure.

### DETAILED DESCRIPTION

The following detailed description sets forth examples of apparatuses, methods, and systems relating to enabling a conference call system with feedback in accordance with an embodiment of the present disclosure. Features such as structure(s), function(s), and/or characteristic(s), for example, are described with reference to one embodiment as a matter of convenience; various embodiments may be implemented with any suitable one or more of the described features.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In some current conference call systems, there may be feedback on aspects of the conference call between the presenter and participants aided by a server. However, those systems do not provide feedback to confirm the quality of audio and/or video received by a participant. In an example, a conference call system with feedback can help allow a presenter to know if audio and/or visual content (e.g., presentation material) are being received by participants of the conference call. During a conference call, especially a large conference call (e.g., over twenty-five (25) participants), it can be difficult to determine if all the participants are receiving audio and/or visual content and a presenter of the conference call does not know if the participants are receiving the audio and/or visual content. The system described herein can help create a feedback monitoring system so a presenter can determine if audio and/or video is being received by a participant's device. For example, an audio monitoring engine and an audio-conference status engine can be used to help determine if audio from the presenter is being communicated to a device associated with a participant and/or a visual content monitoring engine and a video-conference status engine can be used to help determine if visual content (e.g., visual presentation material, video, etc.) from the presenter is being communicated to the device associated with a participant.

More specifically, instead of having participants all confirm that they can hear the audio and/or can see visual content material, the system can automatically (without direct instructions or input from a user) monitor the incoming audio data and/or visual content data. In an illustrative example, on each device associated with a participant in the conference call, an audio monitoring engine monitors the incoming audio data and provides feedback to an audio-conference status engine. The audio-conference status engine communicates the status of the audio on the device to a network conferencing engine that is the central hub for the conference call. The network conferencing engine can aggregate all of the received data about the audio from each device and communicate, to the presenter, what specific devices did not receive audio data, a percentage that did not receive audio data, etc. The presenter can then decide to repeat or resend the audio data, take some other action, or not take any action.

In addition, on each device associated with a participant in the conference call, a visual content monitoring engine monitors the incoming visual content data and provides feedback to a video-conference status engine. The video-conference status engine communicates the status of the visual content on the device to the network conferencing engine that is the central hub for the conference call. The network conferencing engine can aggregate all of the received data about the visual content from each device and communicate, to the presenter, what specific devices did not receive visual content data, a percentage that did not receive visual content data, etc. The presenter can then decide to resend the visual content data, take some other action, or not take any action.

In some examples, a context engine from the presenter can send a code that corresponds to a lookup table and the code is sent to all the receivers. The code can represent a specific query or one or more actions. For example, a presenter may say “Can you hear me?” The context engine can convert the phrase to a query that is sent to the participant's device. In an example, the context engine at the receiver end can use a lookup table to convert the phrase to the query and the query can be a hex code or some other code. The lookup table can accommodate the use of similar phrases and different languages. For example, the phrase “Can you hear me?” and “Hello?” can trigger the same query. A reply to the query can be sent to the presenter.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example. The term “about” includes a plus or minus twenty percent (±20%) variation. For example, about one (1) second would include one (1) second and ±0.2 seconds from one (1) second.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments.

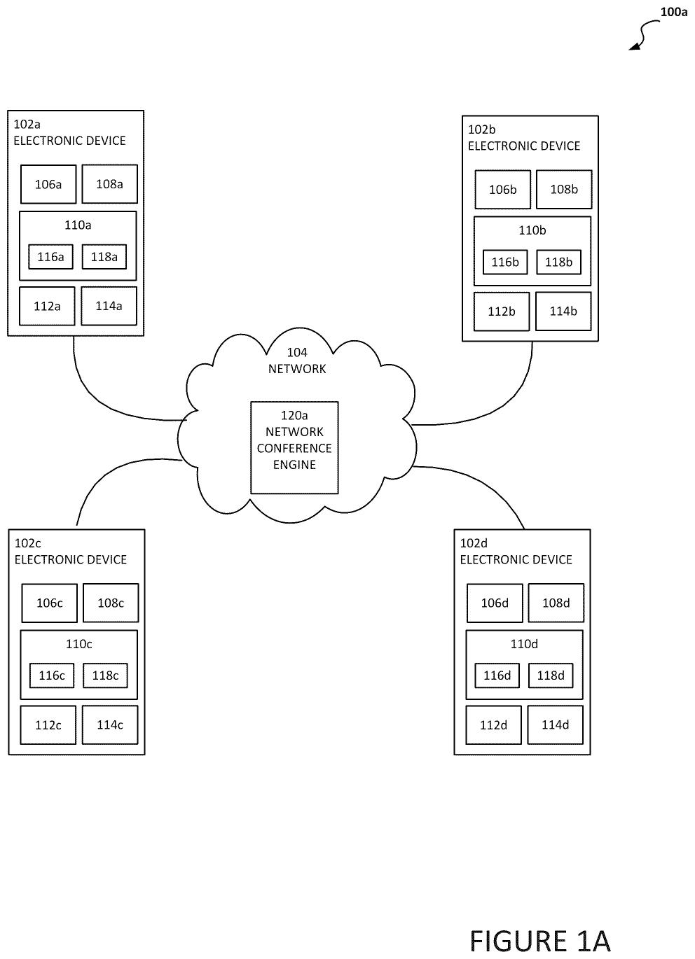

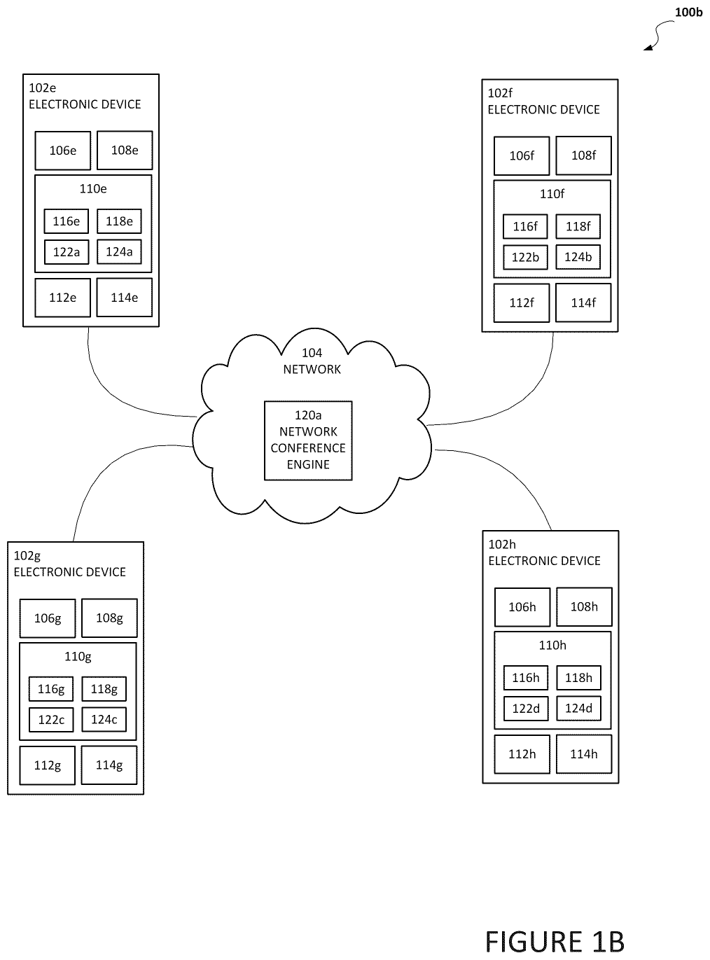

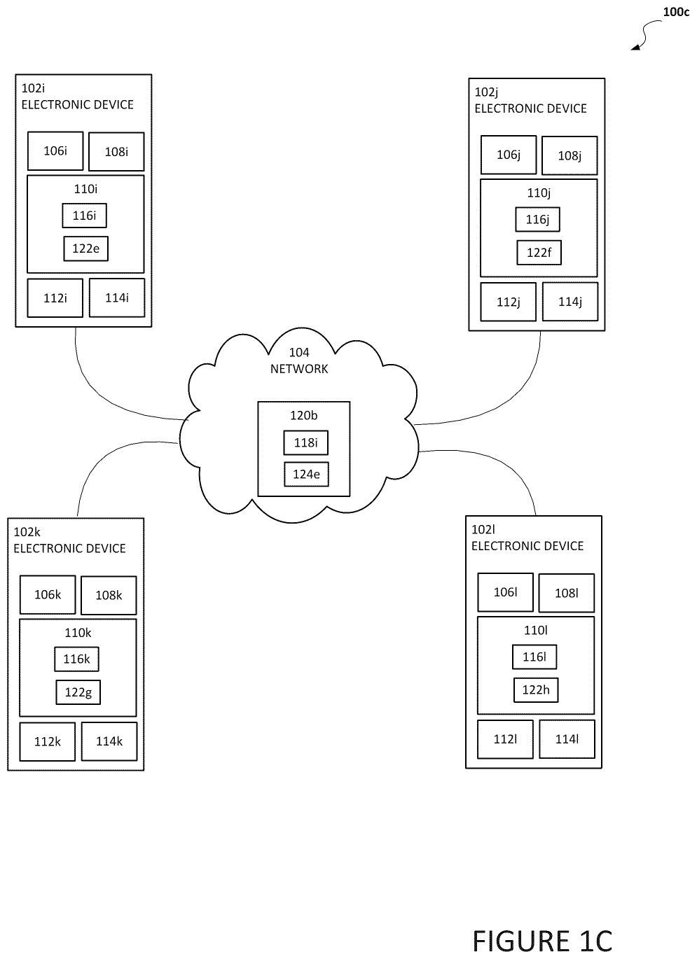

FIG. 1A is a simplified block diagram of a conference call system with feedback 100a, in accordance with an embodiment of the present disclosure. In an example, the conference call system with feedback 100a can include a plurality of electronic devices 102 in communication with each other using a network 104. More specifically, as illustrated in FIG. 1A, the conference call system with feedback 100a can include electronic devices 102a-102d. The electronic devices 102a-102d can be in communication with each other using the network 104. Each of the electronic devices 102a-102d can include memory 106, a processor 108, a communication engine 110, an audio system 112, and a display 114. More specifically, as illustrated in FIG. 1A, the electronic device 102a can include memory 106a, a processor 108a, a communication engine 110a, an audio system 112a, and a display 114a, the electronic device 102b can include memory 106b, a processor 108b, a communication engine 110b, an audio system 112b, and a display 114b, the electronic device 102c can include memory 106c, a processor 108c, a communication engine 110c, an audio system 112c, and a display 114c, and the electronic device 102d can include memory 106d, a processor 108d, a communication engine 110d, an audio system 112d, and a display 114d. The communication engine 110 can include an audio monitoring engine 116 and an audio-conference status engine 118. More specifically, as illustrated in FIG. 1A, the communication engine 110a can include an audio monitoring engine 116a and an audio-conference status engine 118a, the communication engine 110b can include an audio monitoring engine 116b and an audio-conference status engine 118b, the communication engine 110c can include an audio monitoring engine 116c and an audio-conference status engine 118c, and the communication engine 110d can include an audio monitoring engine 116d and an audio-conference status engine 118d. The network 104 can include a network conferencing engine 120a. The network conferencing engine 120a can be the central hub for the conference call and can be configured to performing switching and mixing functions to help allow the electronic devices 102a-102d located at different sites to participate in the same conference call. In an example, the network conferencing engine 120a is located in one or more servers. In another example, the network conferencing engine 120a is located in a cloud.

In an illustrative example, users use the electronic devices 102a-102d to engage in a conference call. More specifically, a presenter user who is speaking uses the electronic device 102d to send voice data to participant users who are listening using the electronic devices 102a-102c. The conference call system with feedback 100a can be configured to determine a quality of audio received by the participant users who are listening using the electronic devices 102a-102c and, when the determined quality of audio is below an audio volume threshold, communicate a message to the presenter user who is speaking using the electronic device 102d. In some examples, the conference call system with feedback 100a can communicate the determined quality of audio to the presenter user who is speaking using the electronic device 102d (e.g., a green light or check mark icon when the quality of audio is above the audio volume threshold and a red light or “x” when the quality of audio is below the audio volume threshold). The term “quality of audio” is used to describe the strength of the audio (e.g., dB level of the audio) during the conference call and a “low quality of audio” is audio that is below the audio volume threshold (described below) and is at a level where a participant user cannot clearly hear the audio. It will be apparent to one skilled in the art that while the examples herein discuss a single audio frame or instance of audio data and/or a single video frame or instance of video data, the embodiments, illustrative implementations, and examples discussed herein are applicable to a sequence of samples in a stream of audio and video data. For example, the quality of audio can be a trend of a metric over time and can be determined using a representation of a sequence of samples. The representation of the sequence of samples can be a moving average over a window of samples or an audio quality metric (e.g., peak signal-to-noise ratio (PSNR)) measured over a moving window of samples.

In an illustrative example, the audio monitoring engine 116 can sample the audio data from the presenter being used by the audio system 112 (e.g., speaker device/headset device/audio jack, etc.) to communicate the voice data from the presenter user who is speaking to the participant users who are listening. The audio data sampled by the audio monitoring engine 116 is communicated from the audio monitoring engine 116 to the audio-conference status engine 118. The audio-conference status engine 118 determines the quality and strength of the incoming audio data and communicates a message to the network conferencing engine 120a when the determined quality of audio is below an audio volume threshold. The network conferencing engine 120a can communicate a message to the presenter user who is speaking when the determined quality of audio is below the audio volume threshold. In some examples, the audio-conference status engine 118 determines the quality and strength of the incoming audio data and communicates the determined quality of audio to the network conferencing engine 120a and the network conferencing engine 120a can communicate the determined quality of audio to the electronic device associated with the presenter user who is speaking (e.g., the electronic device 102d). The presenter user who is speaking can choose to repeat any audio, take some other action, or not take any action. In some examples, the display 114d on the electronic device 102d being used by the presenter user who is speaking can be updated to indicate visual feedback related to the audio data received by the participant users who are listening (e.g., a green light or check mark icon when the quality of audio is above the audio volume threshold and a red light or “x” when the quality of audio is below the audio volume threshold).

Turning to FIG. 1B, FIG. 1B is a simplified block diagram of a conference call system with feedback 100b, in accordance with an embodiment of the present disclosure. In an example, the conference call system with feedback 100b can include a plurality of electronic devices 102 in communication with each other using the network 104. More specifically, as illustrated in FIG. 1B, the conference call system with feedback 100b can include electronic devices 102e-102h. The electronic devices 102e-102h can be in communication with each other using the network 104. Each of the electronic devices 102e-102h can include memory 106, a processor 108, a communication engine 110, an audio system 112, and a display 114. More specifically, as illustrated in FIG. 1B, the electronic device 102e can include memory 106e, a processor 108e, a communication engine 110e, an audio system 112e, and a display 114e, the electronic device 102f can include memory 106f, a processor 108f, a communication engine 110f, an audio system 112f, and a display 114f, the electronic device 102g can include memory 106g, a processor 108g, a communication engine 110g, an audio system 112g, and a display 114g, and the electronic device 102h can include memory 106h, a processor 108h, a communication engine 110h, an audio system 112h, and a display 114h. The communication engine 110 can include the audio monitoring engine 116, the audio-conference status engine 118, a visual content monitoring engine 122, and a video-conference status engine 124. More specifically, as illustrated in FIG. 1B, the communication engine 110e can include an audio monitoring engine 116e, an audio-conference status engine 118e, a visual content monitoring engine 122a, and a video-conference status engine 124a, the communication engine 110f can include an audio monitoring engine 116f, an audio-conference status engine 118f, a visual content monitoring engine 122b, and a video-conference status engine 124b, the communication engine 110g can include an audio monitoring engine 116g, an audio-conference status engine 118g, a visual content monitoring engine 122c, and a video-conference status engine 124c, and the communication engine 110h can include an audio monitoring engine 116h, an audio-conference status engine 118h, a visual content monitoring engine 122d, and a video-conference status engine 124d. The network 104 can include a network conferencing engine 120a.

In an illustrative example, users use electronic devices 102e-102h to engage in a conference call. More specifically, a presenter user who is presenting uses the electronic device 102h to send voice data and visual content data to participant users who are listening to the conference call and viewing the visual content using the electronic devices 102e-102h. The conference call system with feedback 100b can be configured to determine a quality of audio and verify the visual content received by the participant users who are listening to the conference call and viewing the visual content using the electronic devices 102e-102g and communicate the determined quality of audio and the determined verification of the visual content to the presenter user who is presenting the audio and/or the visual content using the electronic device 102h.

In an illustrative example, the audio monitoring engine 112 can sample the audio data being used by the audio system 112 (e.g., speaker device/headset device/audio jack, etc.) that is being used to communicate the voice data from the presenter user who is speaking to the participant users who are listening. The audio data sampled by the audio monitoring engine 116 is communicated from the audio monitoring engine 116 to the audio-conference status engine 118. The audio-conference status engine 118 determines the quality and strength of the incoming audio data and communicates the determined quality of audio to the network conferencing engine 120a. The network conferencing engine 120a can communicate the determined quality of audio data to the electronic device associated with the presenter user who is speaking (e.g., the electronic device 102d). In some examples, the quality of the audio data is communicated to the presenter user only when the quality of the audio data is below an audio volume threshold. If the quality of audio is below the audio volume threshold, the presenter user who is speaking can choose to repeat any missed audio, take some other action, or not take any action. In some examples, the display 114 on the electronic device 102 of the presenter user can be updated to indicate the feedback related to the audio data received by the participant users who are listening.

In addition, the visual content monitoring engine 122 can verify the visual content data being used by the display 114 to communicate the visual content data from the presenter user to the participant users who are viewing the visual content. The visual content data verified by the visual content monitoring engine 122 is communicated from the visual content monitoring engine 122 to the video-conference status engine 124. The video-conference status engine 124 can communicate the determined verification of the visual content data to the network conferencing engine 120a.

In some examples, the visual content monitoring engine 122 can compare the visual content data being used by the display 114 to a signature of the visual content or some other identifier or means that can be used to verify the visual content sent by the presenter but the visual content monitoring engine 122 does not verify the visual content. The visual content monitoring engine 122 can communicate the results of the comparison of the visual content data being used by the display 114 to the signature of the visual content, or some other identifier or means, to the video conference status engine 124. The video-conference status engine 124 can verify the incoming the visual content data and communicate the determined verification of the visual content data to the network conferencing engine 120a. The network conferencing engine 120a can communicate the verification of visual content received by the participant users who are viewing the visual content to the electronic device associated with the presenter user who is presenting the visual content (e.g., electronic device 102d). If the visual content is not verified, the presenter user who is presenting can choose to repeat any missed visual content, take some other action, or not take any action. In some examples, the display 114 on the electronic device 102 of the presenter user can be updated to indicating the feedback related to the visual content data received by the participant users who are viewing the visual content.

Turning to FIG. 1C, FIG. 1C is a simplified block diagram of a conference call system with feedback 100c, in accordance with an embodiment of the present disclosure. In an example, the conference call system with feedback 100c can include a plurality of electronic devices 102 in communication with each other using the network 104. More specifically, as illustrated in FIG. 1C, the conference call system with feedback 100c can include electronic devices 102i-102l. The electronic devices 102i-102l can be in communication with each other using the network 104. Each of the electronic devices 102i-102l can include memory 106, a processor 108, a communication engine 110, an audio system 112, and a display 114. More specifically, as illustrated in FIG. 1C, the electronic device 102i can include memory 106i, a processor 108i, a communication engine 110i, an audio system 112i, and a display 114i, the electronic device 102j can include memory 106j, a processor 108j, a communication engine 110j, an audio system 112j, and a display 114j, the electronic device 102k can include memory 106k, a processor 108k, a communication engine 110k, an audio system 112k, and a display 114k, and the electronic device 102l can include memory 106l, a processor 108l, a communication engine 110l, an audio system 112l, and a display 114l. The communication engine 110 can include the audio monitoring engine 116 and the visual content monitoring engine 122. More specifically, as illustrated in FIG. 1C, the communication engine 110i can include an audio monitoring engine 116i and a visual content monitoring engine 122e, the communication engine 110j can include an audio monitoring engine 116j and a visual content monitoring engine 122f, the communication engine 110k can include an audio monitoring engine 116k and a visual content monitoring engine 122g, and the communication engine 110l can include an audio monitoring engine 116l and a visual content monitoring engine 122h. The network 104 can include a network conferencing engine 120b. The network conferencing engine 120b can include an audio-conference status engine 118i and a video-conference status engine 124e. In an example, the network conferencing engine 120b is located in one or more servers. In another example, the network conferencing engine 120b is located in a cloud.

In an illustrative example, users use the electronic devices 102i-102l to engage in a conference call. More specifically, a presenter user who is presenting uses the electronic device 102l to send voice data and visual content data to participant users who are listening to the conference call and viewing the visual content using the electronic devices 102i-102k. The conference call system with feedback 100c can be configured to determine a quality of audio and verify the visual content received by the participant users who are listening to and viewing the visual content using the electronic devices 102i-102l and communicate the determined quality of audio and the verification of the visual content to the presenter user who is presenting the audio and/or visual content using the electronic device 102l.

In an illustrative example, the audio monitoring engine 116 can sample the audio data being used by the audio system 112 (e.g., speaker device/headset device/audio jack, etc.) that is being used to communicate the voice data from the presenter user who is speaking to the participant users who are listening. The audio data sampled by the audio monitoring engine 116 is communicated from the audio monitoring engine 116 to the audio-conference status engine 118i in the network conferencing engine 120b. The audio-conference status engine 118i determines the quality and strength of the incoming audio data and, using the network conferencing engine 120a, can communicate the quality of audio reception to the electronic device associated with the presenter user who is speaking (e.g., the electronic device 102l). If there is a problem with the audio, the presenter user who is speaking can choose to repeat any audio, take some other action, or not take any action. In some examples, the display 114l on the electronic device 102l associated with the presenter user can be updated to indicate the feedback related to the audio data received by the participant users who are listening.

In addition, the visual content monitoring engine 122 can verify the visual content data being used by the display 114 that is being used to communicate the visual content data from the presenter user to the participant users who are viewing the visual content. The visual content data verified by the visual content monitoring engine 122 is communicated from the visual content monitoring engine 122 to the video-conference status engine 124e in the network conferencing engine 120b. The video-conference status engine 124e can communicate the determined verification of the visual content data to the network conferencing engine 120b.

In some examples, the visual content monitoring engine 122 can compare the visual content data being used by the display 114 to a signature of the visual content or some other identifier or means that can be used to verify the visual content sent by the presenter but the visual content monitoring engine 122 does not verify the visual content. The visual content monitoring engine 122 can communicate the results of the comparison of the visual content data being used by the display 114 to the signature of the visual content, or some other identifier or means, to the video conference status engine 124e. The video-conference status engine 124 verifies the incoming visual content data and, using the network conferencing engine 120b, can communicate the verification of the visual content received by the participant users to the electronic device associated with the presenter user who is presenting the visual content (e.g., the electronic device 102l). If there is a problem with the visual content, the presenter user who is presenting can choose to repeat any visual content, take some other action, or not take any action. In some examples, the display 114l on the electronic device 102l of the presenter user can be updated to indicating the feedback related to the visual content data received by the participant users who are viewing the visual content.

In an illustrative example, each of the audio monitoring engines 116 can set two thresholds, an audio volume threshold and a lost-sample threshold. The audio volume threshold and the lost sample threshold can be unique for each electronic device 102 or one or more of the audio volume threshold and the lost sample threshold may be the same for one or more electronic devices. The audio volume threshold is a lower threshold of an average of audio volume that is observed in the initial few moments of start of the conference call. The lost sample threshold is a predetermined number of audio samples (e.g., about three (3) consecutive audio samples to about six (6) consecutive audio samples, about five (5) consecutive audio samples, more than four (4) consecutive audio samples, ten (10) alternating audio samples, or some other predetermined number of audio samples, depending on design choice and/or design constraints) that are less than the audio volume threshold over a predetermined amount of time (e.g., about one (1) to about three (3) seconds or some other predetermined amount of time, depending on design choice and/or design constraints). The lost sample threshold is used by the audio monitoring engine 116 to determine when there is no audio data and/or the audio volume is below the audio volume threshold and the quality of the audio is not at a level where a participant user can hear the audio from the presenter user.

The network 104 represents a series of points or nodes of interconnected communication paths for receiving and transmitting packets of information. The network 104 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication. The network can 104 can include one or more servers, cloud services, and/or network elements.

In the network 104, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Messages through the network could be made in accordance with various network protocols, (e.g., Ethernet, Infiniband, OmniPath, etc.). Additionally, radio signal communications over a cellular network may also be provided. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks.

It is to be understood that other embodiments may be utilized and structural changes may be made without departing from the scope of the present disclosure. Substantial flexibility is provided by an electronic device in that any suitable arrangements and configuration may be provided without departing from the teachings of the present disclosure.

For purposes of illustrating certain example techniques of the conference call system with feedback 100, the following foundational information may be viewed as a basis from which the present disclosure may be properly explained. A number of prominent technological trends are currently afoot (e.g., more computing devices, more online video services, more Internet traffic, etc.), and these trends are changing the media delivery landscape. One change is the use of web conferencing for conference calls where users can remotely connect to each other over a network without having to be physically in the same room.

Generally, web conferencing for conference calls is used as an umbrella term for various types of online conferencing and collaborative services including webinars (web seminars), webcasts, and web meetings. Sometimes it may also be used in the more narrow sense of the peer-level web meeting context, in an attempt to disambiguate it from the other types known as collaborative sessions. In general, web conferencing for conference calls is made possible by Internet technologies, particularly on TCP/IP connections. Services may allow real-time point-to-point communications as well as multicast communications from one sender to many receivers. Web conferencing for conference calls offers data streams of text-based messages, voice and video to be shared simultaneously or near or almost simultaneously, across geographically dispersed locations. Applications for web conferencing for conference calls include meetings, training events, lectures, or presentations from a web-connected computer to other web-connected computers.

Web conferencing for conference calls has become increasingly important in today's society. In certain architectures, service providers may seek to offer sophisticated online meetings services for their participants. The online meeting architecture can offer an “in-person” meeting experience over a network. The online meeting architectures can deliver real-time, face-to-face interactions between people using advanced visual, audio, and/or collaboration technologies.

Web conferencing for conference calls allows two or more locations to interact via simultaneous two-way audio and often video transmissions. The usability of web conferencing systems that allow for video conferencing and telepresence needs to be able to serve multiple purposes such as connect separate locations by high quality two-way audio links and video links (if video is available). Web conferencing systems typically include a number of end-points communicating in real-time using various networks such as WAN, LAN, and circuit switched networks to help facilitate the conference call. A number of web conferencing systems residing at different sites may participate in the same conference call, most often, through one or more network conference call engines performing switching and mixing functions to allow the audiovisual terminals to intercommunicate properly.

In some current conference call systems, there may be feedback on aspects of the conference call between the presenter and participants aided by the server and/or cloud services. However, there is no reliable and sufficient feedback to confirm the quality of audio received by a participant. Some current systems use concepts like voice activity detection (VAD) to try and provide feedback to confirm the quality of audio received by a participant. VAD, also known as speech activity detection or speech detection, is the detection of the presence or absence of human speech, and is typically used in speech processing. The main uses of VAD are in speech coding and speech recognition. VAD can facilitate speech processing and can also be used to deactivate some processes during non-speech section of an audio session. In addition, VAD can avoid unnecessary coding/transmission of silence packets in Voice over Internet Protocol (VoIP) applications to save on network bandwidth and computation. However, VAD can be processor intensive and VAD requires the performance of complex operations to solve problems like noise and transmission. Also, VAD inserts silence frames and but does not confirm if a remote end did or did not receive the audio and/or visual content. What is needed is a system and method to help provide a conference call system with feedback that can help confirm if audio and/or visual content were received by a participant of the conference call.

A system and method to help provide a conference call system with feedback can resolve these issues (and others). In an example, a web conferencing system to help enable a conference call system with feedback (e.g., conference call system with feedback 100a, 100b, and/or 100c) can include an audio monitoring engine to monitor audio received by a receiver. The status of the audio can be communicated to the presenter. In another example, the web conferencing system can include an audio monitoring engine and a visual content monitoring engine to monitor audio and visual content received by a receiver. The status of the audio content and verification of the visual content can be communicated to the presenter. The system can provide feedback to inform the presenter if the audio of the presenter's voice was communicated in a way to allow the audio to be heard by one or more participants and if visual content was displayed on the display to be viewed by the one or more participants. The system not only applies between human-to-human communication, but also when there is communication between human to BOT (e.g., a software program that performs automated, repetitive, pre-defined tasks that imitate and/or replace a human user) and can help the BOT to determine issues on the human user side and vice versa.

More specifically, the web conferencing system can include an audio monitoring engine to monitor audio received by a receiver. Depending up on the type of encoding (e.g., AMR-WB, Silk audio codec, G.722, HD capable, etc.) used by the network conference engine, audio data will be transferred in a wide range of frames rates of audio similar to video frames. The network conference engine is aware of the audio frame rate and the network conference engine can pass the audio frame rate information to the audio monitoring engine. The content of the frame (the actual voice data, encoding format, bit rate, language, audio latency, etc.) are immaterial because the audio monitoring engine is detecting lost audio frames or jittery speech and the detection is not dependent on the type of content.

Currently, there are existing systems that can provide notifications about bandwidth issue, presenter/participant mute/unmute, etc. However, the notification from the network conference engine about bandwidth issue, presenter/participant mute/unmute, etc. does not address feedback to the presenter on individual issues of audio quality and/or the display of visual content experienced by one or more participants. Some of the existing feedback (e.g., an icon that shows who is muted, highlighting the current presenter, etc.) is based on error/issue/logic detected by the network conference engine or the communication engine or on user actions. All participants (presenters and participants) have the ability to know who is muted (either forced by someone or by a control set by the host.). Also, if a host mutes a participant, it is made known to the participant and the host. There are multiple such feedbacks existing in some current systems and the conference call system with feedback (e.g., the conference call systems with feedback 100a, 100b, and 100c) do not enhance or downgrade such feedbacks.

In an illustrative example, the audio monitoring engine can set two thresholds, an audio volume threshold and a lost-sample threshold. The audio volume threshold is a lower threshold of an average of audio volume that is observed in the initial few moments of the start of the conference call and/or an average of the audio value during a previous predetermined amount of time (e.g., about two (2) to about three (3) minutes or some other period of time depending on design choice and design constraints). The audio monitoring engine can be a sensor hub-based system, a digital signal processor-based system, or some other type of system. In a sensor hub-based system, the audio volume is an analog to digital converter value of the actual audio level. In a digital signal processor-based system, the audio volume is the audio decibel reported by the digital signal processor. The audio monitoring engine samples the incoming audio data and can determine when there is no audio data and/or the audio volume is below the audio volume threshold and the quality of the audio is not at a level where a user can hear the audio from the presenter. When there is no audio data and/or the audio volume is below the audio volume, for a specific number of samples (e.g., about three (3) consecutive audio samples to about six (6) consecutive audio samples, about five (5) consecutive audio samples, more than four (4) consecutive audio samples, ten (10) alternating audio samples, or some other predetermined number of audio samples, depending on design choice and/or design constraints) the audio monitoring engine can trigger a threshold lost sample count. A threshold for the lost sample count, is a lost sample threshold. The vocabulary, accent, style, phonetic or other speech related characteristics are not measured.

More specifically, during the start of a web conference call session the network conference engine, establishes a communication channel with the audio monitoring engine. The audio monitoring engine starts monitoring the audio to check the audio quality. If the audio monitoring engine is sensor hub connected, then the audio monitoring engine enables the sampling of the analog to digital converter to convert the tapped analog audio data into digital audio data and determine the audio volume. If the audio monitoring engine is audio code digital signal processor based, the audio monitoring engine starts to monitor the audio data rate, which is a simple normalized data of audio volume on a per frame basis to determine the audio volume. The audio quality detection is not only a decibel level, but also uninterrupted frames of audio being delivered to a participant. The system can identify such interrupted audio frames (or frames being lost) and provide feedback for missing audio or jittery speech. In either case, the sampling frequency is the frame rate of the display device of the participant's device. The sampling frequency is neither respective to the presenter (at the transmitting end) nor the conference call's audio and video frame rate nor any other setting of the conference call application. This is to ensure that network disturbances or other factors do not affect the sampling frequency. The audio monitoring engine can receive the output from the analog to digital converter, as the analog to digital converter is tapping the signal from the speaker input (which is also the codec's output). The analog to digital converter can sample this analog signal at a sampling frequency as explained above. If the audio monitoring engine is digital signal processor based, then the digital signal processor provides the audio volume as digital data to the audio monitoring engine, sampled at a sampling frequency as explained above.

In an example, the audio volume threshold is a value created for every conference call session. More specifically, when the conference call starts, for about two (2) to about three (3) minutes (or some other period of time depending on design choice and design constraints), the incoming audio volume levels (in decibels) are measured by the analog to digital converter or the digital signal processor. In some examples, the audio volume threshold is a value that is continuously updated and is at least partially based on the incoming measured audio volume levels for a past two (2) minutes or more. From the measured audio volume levels, a ‘mean value’ is obtained. A predetermined percentage of the mean value (e.g., thirty percent (30%) or some other percent based on design choice and design constraints) can be treated as the threshold for audio volume. In some examples, the predetermined percentage of the mean value can be derived analytically based on experiments, knowledge of audio fidelity, or other means. The audio volume threshold can help to mitigate the effects of background noise includes hissing or background noise in the environment, low volume and relatively constant noise (e.g., from a fan, air conditioner, filter noise caused by a microphone, other active and/or passive electrical and non-electrical elements etc.), noise from network elements, and other sources of background noise. More specifically, the higher the background noise, the higher the audio volume threshold. During the call, if the incoming audio's decibel is less than the audio volume threshold for a specific number of samples (lost-sample threshold), the audio monitoring engine can trigger feedback to the network conference call engine regarding lost or jittery audio. The lost sample threshold can help to ensure the detection of true silence as opposed to a loss of audio frames, even when there are multiple presenters at the same instance. For example, if for about two (2) to about three (3) seconds, when the audio monitoring engine detects about ninety percent (90%) to about one-hundred percent (100%) of a lost-sample count, it can be considered as silence.

In some examples, a visual content monitoring engine (e.g., visual content monitoring engine 122) can verify if visual content is delivered to users using visual content verification data. In an illustrative example, the visual content verification data can include reference pixels. More specifically, when a presenter transmits a visual content stream (e.g., video stream, camera/screen share stream, etc.) a set of reference pixels and their corresponding locations can also be sent for content verification. The visual content monitoring engine on each receiving client can extract the reference pixels of received content from corresponding locations and scale the received location of the reference pixels according to the screen size, aspect ratio and application window size of the receiving client. Using reference pixels related to the visual content being presented instead of the entire display or content on the presenter user's display that is not related to the content being presented (e.g., email when the email is not related to the content being presented) can help to avoid security and privacy concerns of content being shared. In an illustrative example, to verify if visual content is delivered to users, a photo image of the presenter, mouse coordinates, and/or the title of the conference call or some pre-defined signatures can be sent for content verification. Other means for visual content verification can include structural visual content quality metrics (e.g., structural similarity (SSIM)) for some transmitted video frames where structural visual content quality metrics can be computed on received frames and compared with received metrics.

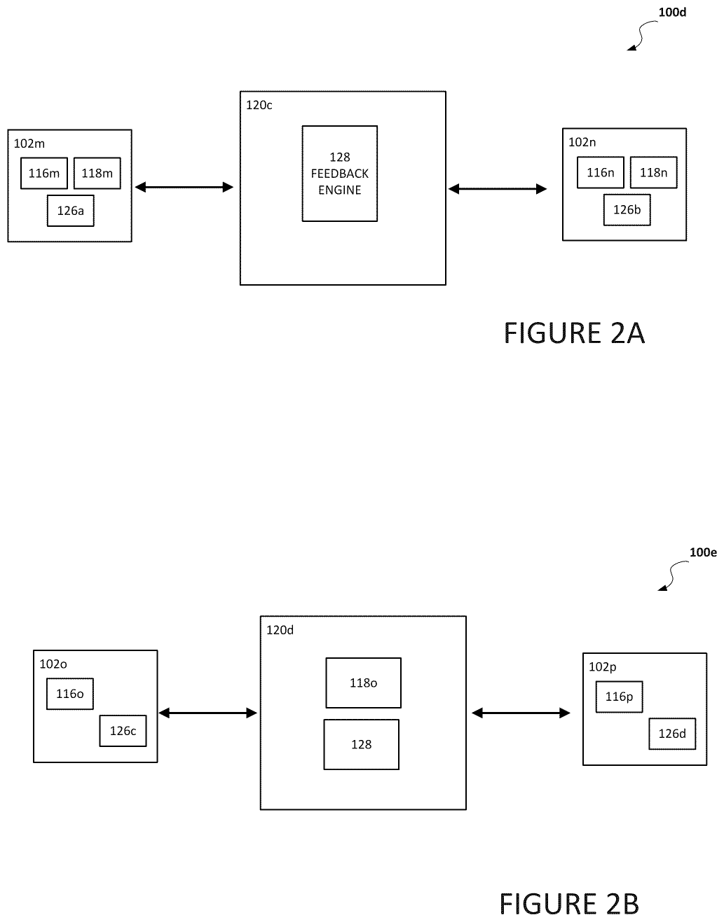

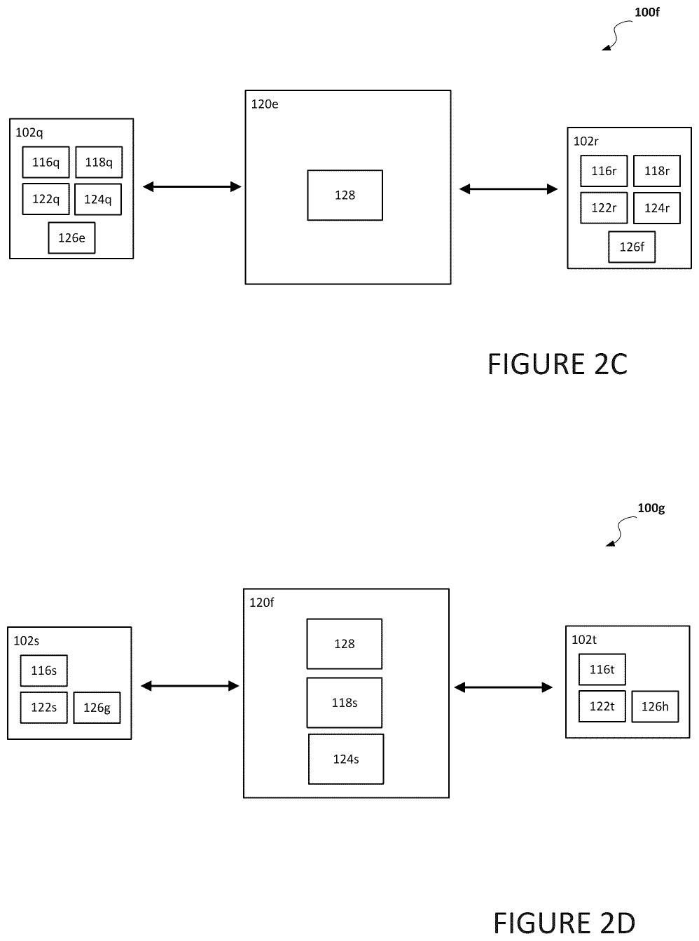

Turning to FIG. 2A, FIG. 2A is a simplified block diagram of a conference call system with feedback 100d, in accordance with an embodiment of the present disclosure. In an example, the conference call system with feedback 100d can include a plurality of electronic devices 102 in communication with each other using the network conferencing engine 120. More specifically, as illustrated in FIG. 2A, the conference call system with feedback 100d can include electronic devices 102m and 102n in communication with each other using a network conferencing engine 120c. It should be noted that more electronic devices 102 can be included in the conference call system with feedback 100d.

Each of the electronic devices 102m and 102n can include the audio monitoring engine 116, the audio-conference status engine 118, and a context engine 126 (along with memory, one or more processors, a communication engine, audio system, display, etc.). More specifically, as illustrated in FIG. 2A, the electronic device 102m can include an audio monitoring engine 116m, an audio-conference status engine 118m, and a context engine 126a and the electronic device 102n can an audio monitoring engine 116n, an audio-conference status engine 118n, and a context engine 126b. The network conferencing engine 120c can include a feedback engine 128.

In an illustrative example, during a phase of a conference call, a user using the electronic device 102m can be speaking to a user using the electronic device 102n. The audio monitoring engine 116n can sample the audio data being used to communicate the voice data from the user of the electronic device 102m that is speaking to the user that is listening using the electronic device 102n. The audio data sampled by the audio monitoring engine 116n is communicated from the audio monitoring engine 116n to the audio-conference status engine 118n. The audio-conference status engine 118n determines the quality and strength of the incoming audio data and can communicate the quality of audio reception at the electronic device 102n to the feedback engine 128 in the network conferencing engine 120c. The feedback engine 128 can received the data related to the quality and strength of the incoming audio data from the audio-conference status engine 118n and communicate a status message to the user using the electronic device 102m to provide feedback regarding the audio received by the electronic device 102n during the conference call.

During another phase of the conference call, the user using the electronic device 102n can be speaking to the user using the electronic device 102m, instead of the user using the electronic device 102m speaking to the user using the electronic device 102n as described above. The audio monitoring engine 116m can sample the audio data being used to communicate the voice data from the user of the electronic device 102n that is speaking to the user that is listening using the electronic device 102m. The audio data sampled by the audio monitoring engine 116m is communicated from the audio monitoring engine 116m to the audio-conference status engine 118m. The audio-conference status engine 118m determines the quality and strength of the incoming audio data and can communicate the quality of audio reception at the electronic device 102m to the feedback engine 128 in the network conferencing engine 120c. The feedback engine 128 can receive the data related to the quality and strength of the incoming audio data from the audio-conference status engine 118m and communicate a status message to the user using the electronic device 102n to provide feedback regarding the audio received by the electronic device 102m during the conference call.

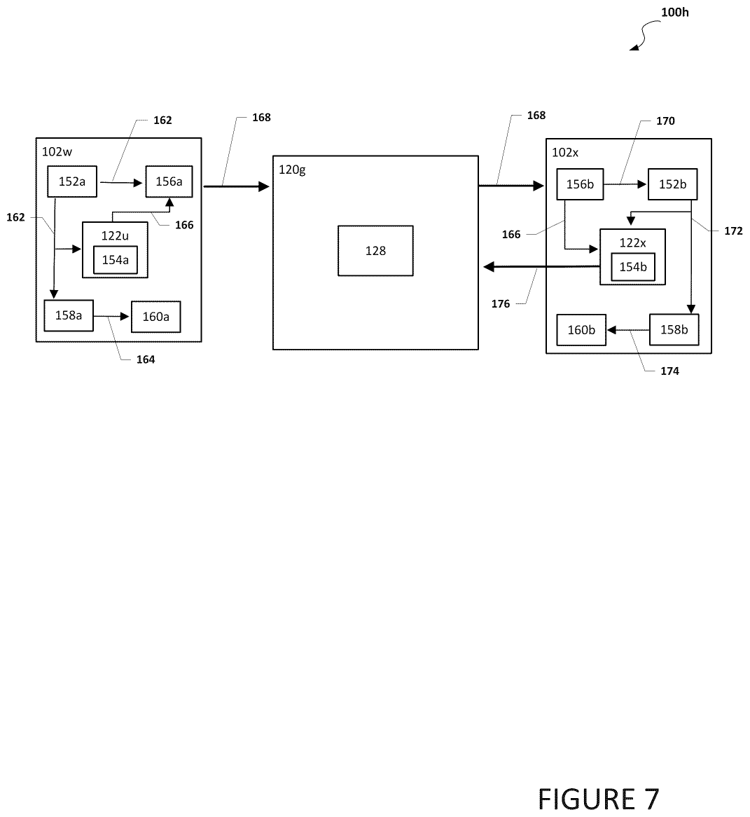

During the conference call, the context engine 126 can be used to detect pre-determined words or phrases spoken by a user and preform pre-designated tasks or queries. More specifically, the user of the electronic device 102m may be speaking and not know if the user of the electronic device 102n can hear. The user of the electronic device 102m may say “can you hear me?” or some other similar pre-determined words or phrase. Based on the detection of the pre-determined words or phrase “can you hear me?” the context engine 126a sends a code or message to the electronic device 102n that corresponds the pre-determined words or phrase “can you hear me?” In an example, the code or message is determined using a lookup table (e.g., as show in FIG. 7). In a specific example, the code is a hex code. The electronic device 102n can use the code or message sent from the context engine 126a in the electronic device 102m and perform the pre-designated task or query associated with the code or message. More specifically, if the context engine 126b in the electronic device 102n receives the code or message that corresponds the pre-determined words or phrase “can you hear me?” the context engine 126b can instruct the audio monitoring engine 116n and the audio-conference status engine 118n in the electronic device 102n to determine the quality and strength of the incoming audio data and communicate the results back to the context engine 126a in the electronic device 102m to be communicated to the user. In some examples, a dedicated channel is used for the communication of the code or message to the electronic devices 102 and for the response.

Turning to FIG. 2B, FIG. 2B is a simplified block diagram of a conference call system with feedback 100e, in accordance with an embodiment of the present disclosure. In an example, the conference call system with feedback 100e can include a plurality of electronic devices 102 in communication with each other using the network conferencing engine 120. More specifically, as illustrated in FIG. 2B, the conference call system with feedback 100e can include electronic devices 102o and 102p in communication with each other using network conferencing engine 120d. It should be noted that more electronic devices 102 can be included in the conference call system with feedback 100e.

Each of the electronic devices 1020 and 102p can include the audio monitoring engine 116 and the context engine 126 (along with memory, one or more processors, a communication engine, audio system, display, etc.). More specifically, as illustrated in FIG. 2B, the electronic device 102o can include an audio monitoring engine 116o and the context engine 126c and the electronic device 102p can an audio monitoring engine 116p and the context engine 126d. The network conferencing engine 120d can include an audio-conference status engine 118o and the feedback engine 128.

In an illustrative example, during a phase of a conference call, a user using the electronic device 102o can be speaking to a user using the electronic device 102p. The audio monitoring engine 116p can sample the audio data being used to communicate the voice data from the user of the electronic device 102o that is speaking to the user that is listening using the electronic device 102p. The audio data sampled by the audio monitoring engine 116p is communicated from the audio monitoring engine 116p to the audio-conference status engine 118o in the network conferencing engine 120d. The audio-conference status engine 118o determines the quality and strength of the incoming audio data and can communicate the quality of audio reception at the electronic device 102o to the feedback engine 128 in the network conferencing engine 120d. The feedback engine 128 can receive the data related to the quality and strength of the transmitted audio data from the audio-conference status engine 118o and communicate a status message to the user using the electronic device 102o to provide feedback regarding the audio received by the electronic device 102n during the conference call.

During another phase of the conference call, the user using the electronic device 102p can be speaking to the user using the electronic device 102o, instead of the user using the electronic device 102o speaking to the user using the electronic device 102p as described above. The audio monitoring engine 116o can sample the audio data being used to communicate the voice data from the user of the electronic device 102p that is speaking to the user that is listening using the electronic device 102o. The audio data sampled by the audio monitoring engine 116o is communicated from the audio monitoring engine 116o to the audio-conference status engine 118o in the network conferencing engine 120d. The audio-conference status engine 118o determines the quality and strength of the incoming audio data and can communicate the quality of audio reception at the electronic device 102o to the feedback engine 128 in the network conferencing engine 120d. The feedback engine 128 can receive the data related to the quality and strength of the transmitted audio data from the audio-conference status engine 118o and communicate a status message to the user using the electronic device 102p to provide feedback regarding the audio received by the electronic device 102o during the conference call.

During the conference call, the context engine 126 can be used to detect pre-determined words or phrases spoken by a user and preform pre-designated tasks or queries. More specifically, the user of the electronic device 102o may be speaking and not know if the user of the electronic device 102p can hear. The user of the electronic device 102o may say “Hello?” or some other similar pre-determined words or phrase. Based on the detection of the pre-determined words or phrase “Hello?” the context engine 126c sends a code or message to the electronic device 102p that corresponds the pre-determined words or phrase “Hello?” In an example, the code or message is determined using a lookup table (e.g., as show in FIG. 7). In a specific example, the code is a hex code. The electronic device 102p can use the code or message sent from the context engine 126c in the electronic device 102o and perform the pre-designated task or query associated with the code or message. More specifically, if the context engine 126d in the electronic device 102p receives the code or message that corresponds the pre-determined words or phrase “Hello?” the context engine 126d can instruct the audio monitoring engine 116p in the electronic device 102p and the audio-conference status engine 118o in the network conferencing engine 120d to determine the quality and strength of the incoming audio data and communicate the results back to the context engine 126c in the electronic device 102o to be communicated to the user. In some examples, a dedicated channel is used for the communication of the code or message to the electronic devices 102 and for the response.

Turning to FIG. 2C, FIG. 2C is a simplified block diagram of a conference call system with feedback 100f, in accordance with an embodiment of the present disclosure. In an example, the conference call system with feedback 100f can include a plurality of electronic devices 102 in communication with each other using the network conferencing engine 120. More specifically, as illustrated in FIG. 2C, the conference call system with feedback 100f can include electronic devices 102q and 102r in communication with each other using a network conferencing engine 120e. It should be noted that more electronic devices 102 can be included in the conference call system with feedback 100f.

Each of the electronic devices 102q and 102r can include the audio monitoring engine 116, the audio-conference status engine 118, the visual content monitoring engine 122, the video-conference status engine 124, and the context engine 126 (along with memory, one or more processors, a communication engine, audio system, display, etc.). More specifically, as illustrated in FIG. 2C, the electronic device 102q can include an audio monitoring engine 116q, an audio-conference status engine 118q, a visual content monitoring engine 122q, a video-conference status engine 124q, and a context engine 126e and the electronic device 102r can include an audio monitoring engine 116r, an audio-conference status engine 118r, a visual content monitoring engine 122r, a video-conference status engine 124r, and a context engine 126f. The network conferencing engine 120e can include a feedback engine 128.

In an illustrative example, during a phase of a conference call, a user using the electronic device 102q can be speaking to a user using the electronic device 102r. The audio monitoring engine 116r can sample the audio data being used to communicate the voice data from the user of the electronic device 102q that is speaking to the user that is listening using the electronic device 102r. The audio data sampled by the audio monitoring engine 116r is communicated from the audio monitoring engine 116r to the audio-conference status engine 118r. The audio-conference status engine 118r determines the quality and strength of the incoming audio data and can communicate the quality of audio reception at the electronic device 102r to the feedback engine 128 in the network conferencing engine 120e. The feedback engine 128 can receive the data related to the quality and strength of the incoming audio data from the audio-conference status engine 118r and communicate a status message to the user using the electronic device 102q to provide feedback regarding the audio received by the electronic device 102r during the conference call.

In addition, during the phase of the conference call, the user using the electronic device 102q can be showing visual information (e.g., an image, video, etc.) to a user using the electronic device 102r that is viewing the visual information. The visual content monitoring engine 122r can verify the visual content data being used to communicate the visual information from the user of the electronic device 102q that is presenting the visual information to the user that is viewing the visual information using the electronic device 102r. The visual content data verified by the visual content monitoring engine 122r is communicated from the visual content monitoring engine 122r to the video-conference status engine 124r. The video-conference status engine 124r can communicate the determined verification of the visual content data to the network conferencing engine 120e.

In some examples, the visual content monitoring engine 122r can compare the visual content data being used by the display (e.g., the display 114) to a signature of the visual content or some other identifier or means that can be used to verify the visual content sent by the presenter but the visual content monitoring engine 122r does not verify the visual content. The visual content monitoring engine 122r can communicate the results of the comparison of the visual content data being used by the display to the signature of the visual content, or some other identifier or means, to the video conference status engine 124r. The video-conference status engine 124r verifies the incoming visual information data and communicates the result of the verification of the visual information data to the feedback engine 128 in the network conferencing engine 120e. The feedback engine 128 can communicate the result of the verification of visual information received by the user of the electronic device 102q to the user of the electronic device 102q that is presenting the visual information.

During another phase of the conference call, the user using the electronic device 102r can be speaking to the user using the electronic device 102q, instead of the user using the electronic device 102q speaking to the user using the electronic device 102r as described above. The audio monitoring engine 116q can sample the audio data being used to communicate the voice data from the user of the electronic device 102r that is speaking to the user that is listening using the electronic device 102q. The audio data sampled by the audio monitoring engine 116q is communicated from the audio monitoring engine 116q to the audio-conference status engine 118q. The audio-conference status engine 118q determines the quality and strength of the incoming audio data and can communicate the quality of audio reception at the electronic device 102q to the feedback engine 128 in the network conferencing engine 120e. The feedback engine 128 can receive the data related to the quality and strength of the incoming audio data from the audio-conference status engine 118q and communicate a status message to the user using the electronic device 102r to provide feedback regarding the audio received by the electronic device 102q during the conference call.

In addition, during the other phase of the conference call, the user using the electronic device 102r can be showing visual information (e.g., an image, video, etc.) to the user using the electronic device 102q. The visual content monitoring engine 122q can verify the visual content data being used to communicate the visual information from the user of the electronic device 102r that is presenting the visual information to the user that is viewing the visual information using the electronic device 102q. The visual content data verified by the visual content monitoring engine 122q is communicated from the visual content monitoring engine 122q to the video-conference status engine 124q. The video-conference status engine 124q can communicate the determined verification of the visual content data to the network conferencing engine 120e.

In some examples, the visual content monitoring engine 122q can compare the visual content data being used by the display (e.g., the display 114) to a signature of the visual content or some other identifier or means that can be used to verify the visual content sent by the presenter but the visual content monitoring engine 122q does not verify the visual content. The visual content monitoring engine 122q can communicate the results of the comparison of the visual content data being used by the display to the signature of the visual content, or some other identifier or means, to the video conference status engine 124q. The video-conference status engine 124q verifies the incoming the visual information data and communicates the result of the verification of the visual information data to the feedback engine 128 in the network conferencing engine 120e. In some examples, the result of the verification of the visual information data is communicated to the feedback engine 128 as blob of data or a hex code. The feedback engine 128 can communicate the result of the verification of visual information received by the user of the electronic device 102q to the user of the electronic device 102r that is presenting the visual information.

During the conference call, the context engine 126 can be used to detect pre-determined words or phrases spoken by a user and preform pre-designated tasks or queries. More specifically, the user of the electronic device 102q may be speaking and/or may be presenting visual information and not know if the user of the electronic device 102r can hear and/or know if the user of the electronic device 102r can see the visual information. The user of the electronic device 102q may say “can you hear me?” or some other similar pre-determined words or phrase. Based on the detection of the pre-determined words or phrase “can you hear me?” the context engine 126e sends a code or message to the electronic device 102r that corresponds the pre-determined words or phrase “can you hear me?” Also, the user of the electronic device 102q may say “can you see the document?” or some other similar pre-determined words or phrase. Based on the detection of the pre-determined words or phrase “can you see the document?” the context engine 126e sends a code or message to the electronic device 102r that corresponds the pre-determined words or phrase “can you see the document?”

In an example, the code or message is determined using a lookup table. In a specific example, the code is a hex code. The electronic device 102r can use the code or message sent from the context engine 126e in the electronic device 102q and perform the pre-designated task or query associated with the code or message. More specifically, if the context engine 126f in the electronic device 102r receives the code or message that corresponds the pre-determined words or phrase “can you hear me?” the context engine 126f can instruct the audio monitoring engine 116r and the audio-conference status engine 118r in the electronic device 102r to determine the quality and strength of the incoming audio data and communicate the results back to the context engine 126e in the electronic device 102q to be communicated to the user. More specifically, if the context engine 126f in the electronic device 102r receives the code or message that corresponds the pre-determined words or phrase “can you see the document?” the context engine 126f can instruct the visual content monitoring engine 122r and the video-conference status engine 124r in the electronic device 102r to verify the incoming the visual content data and communicate the results back to the context engine 126e in the electronic device 102q to be communicated to the user. In some examples, a dedicated channel is used for the communication of the code or message to the electronic devices 102 and for the response.

Turning to FIG. 2D, FIG. 2D is a simplified block diagram of a conference call system with feedback 100g, in accordance with an embodiment of the present disclosure. In an example, the conference call system with feedback 100g can include a plurality of electronic devices 102 in communication with each other using the network conferencing engine 120. More specifically, as illustrated in FIG. 2D, the conference call system with feedback 100g can include electronic devices 102s and 102t in communication with each other using a network conferencing engine 120f. It should be noted that more electronic devices 102 can be included in the conference call system with feedback 100g.

Each of the electronic devices 102s and 102t can include the audio monitoring engine 116, the audio-conference status engine 118, the visual content monitoring engine 122, the video-conference status engine 124, and the context engine 126 (along with memory, one or more processors, a communication engine, audio system, display, etc.). More specifically, as illustrated in FIG. 2D, the electronic device 102s can include an audio monitoring engine 116s, a visual content monitoring engine 122s, and a context engine 126g and the electronic device 102t can include an audio monitoring engine 116t, a visual content monitoring engine 122t, and a context engine 126h. The network conferencing engine 120f can include an audio-conference status engine 118s, a video-conference status engine 124s, and the feedback engine 128.

In an illustrative example, during a phase of conference call, a user using the electronic device 102s can be speaking to a user using the electronic device 102t. The audio monitoring engine 116t can sample the audio data being used to communicate the voice data from the user of the electronic device 102s that is speaking to the user that is listening using the electronic device 102t. The audio data sampled by the audio monitoring engine 116t is communicated from the audio monitoring engine 116t to the audio-conference status engine 118s in the network conferencing engine 120f. The audio-conference status engine 118s determines the quality and strength of the incoming audio data and can communicate the quality of audio reception at the electronic device 102t to the feedback engine 128. The feedback engine 128 can received the data related to the quality and strength of the incoming audio data from the audio-conference status engine 118s and communicate a status message to the user using the electronic device 102s to provide feedback regarding the audio received by the electronic device 102t during the conference call.

In addition, during the phase of the conference call, the user using the electronic device 102s can be showing visual information (e.g., an image, video, etc.) to a user using the electronic device 102t. The visual content monitoring engine 122s can verify the visual content data being used to communicate the visual information from the user of the electronic device 102s that is presenting the visual information to the user that is viewing the visual information using the electronic device 102t. The visual content data verified by the visual content monitoring engine 122t is communicated from the visual content monitoring engine 122t to the video-conference status engine 124s in the network conferencing engine 120f. The video-conference status engine 124s can communicate the determined verification of the visual content data to the network conferencing engine 120f.

In some examples, the visual content monitoring engine 122t can compare the visual content data being used by the display (e.g., the display 114) to a signature of the visual content or some other identifier or means that can be used to verify the visual content sent by the presenter but the visual content monitoring engine 122t does not verify the visual content. The visual content monitoring engine 122t can communicate the results of the comparison of the visual content data being used by the display to the signature of the visual content or some other identifier or means to the video conference status engine 124s. The video-conference status engine 124s verifies the incoming visual information data and communicates the result of the verification of the visual information data to the feedback engine 128 in the network conferencing engine 120f. The feedback engine 128 can communicate the result of the verification of visual information received by the user of the electronic device 102t to the user of the electronic device 102s that is presenting the visual information.

During another phase of the conference call, the user using the electronic device 102t can be speaking to the user using the electronic device 102s, instead of the user using the electronic device 102s speaking to the user using the electronic device 102t as described above. The audio monitoring engine 116s can sample the audio data being used to communicate the voice data from the user of the electronic device 102t that is speaking to the user that is listening using the electronic device 102s. The audio data sampled by the audio monitoring engine 116s is communicated from the audio monitoring engine 116s to the audio-conference status engine 118s in the network conferencing engine 120f. The audio-conference status engine 118s determines the quality and strength of the incoming audio data and can communicate the quality of audio reception at the electronic device 102s to the feedback engine 128. The feedback engine 128 can receive the data related to the quality and strength of the incoming audio data from the audio-conference status engine 118s and communicate a status message to the user using the electronic device 102t to provide feedback regarding the audio received by the electronic device 102s during the conference call.

In addition, during the other phase of the conference call, the user using the electronic device 102t can be showing visual information (e.g., an image, video, etc.) to the user using the electronic device 102s. The visual content monitoring engine 122t can verify the visual content data being used to communicate the visual information from the user of the electronic device 102t that is presenting the visual information to the user that is viewing the visual information using the electronic device 102s. The visual content data verified by the visual content monitoring engine 122t is communicated from the visual content monitoring engine 122t to the video-conference status engine 124s in the network conferencing engine 120f. The video-conference status engine 124s can communicate the determined verification of the visual content data to the network conferencing engine 120f.

In some examples, the visual content monitoring engine 122t can compare the visual content data being used by the display (e.g., the display 114) to a signature of the visual content or some other identifier or means that can be used to verify the visual content sent by the presenter but the visual content monitoring engine 122t does not verify the visual content. The visual content monitoring engine 122t can communicate the results of the comparison of the visual content data being used by the display to the signature of the visual content or some other identifier or means to the video conference status engine 124s. The video-conference status engine 124s verifies the incoming the visual information data and communicates the result of the verification of the visual information data to the feedback engine 128 in the network conferencing engine 120f. The feedback engine 128 can communicate the result of the verification of visual information received by the user of the electronic device 102s to the user of the electronic device 102t that is presenting the visual information.

During the conference call, the context engine 126 can be used to detect pre-determined words or phrases spoken by a user and preform pre-designated tasks or queries. More specifically, the user of the electronic device 102s may be speaking and not know if the user of the electronic device 102t can hear and/or may be presenting visual information and know if the user of the electronic device 102t can see the visual information. The user of the electronic device 102s may say “can you hear me?” or some other similar pre-determined words or phrase. Based on the detection of the pre-determined words or phrase “can you hear me?” the context engine 126g sends a code or message to the electronic device 102t that corresponds the pre-determined words or phrase “can you hear me?” Also, the user of the electronic device 102s may say “can you see the document?” or some other similar pre-determined words or phrase. Based on the detection of the pre-determined words or phrase “can you see the document?” the context engine 126g sends a code or message to the electronic device 102t that corresponds the pre-determined words or phrase “can you see the document?”

In an example, the code or message is determined using a lookup table. In a specific example, the code is a hex code. The electronic device 102t can use the code or message sent from the context engine 126g in the electronic device 102s and perform the pre-designated task or query associated with the code or message. More specifically, if the context engine 126h in the electronic device 102t receives the code or message that corresponds the pre-determined words or phrase “can you hear me?” the context engine 126h can instruct the audio monitoring engine 116t in the electronic device 102t and the audio-conference status engine 118t in the network conferencing engine 120f to determine the quality and strength of the incoming audio data and communicate the results back to the context engine 126g in the electronic device 102s to be communicated to the user. More specifically, if the context engine 126h in the electronic device 102t receives the code or message that corresponds the pre-determined words or phrase “can you see the document?” the context engine 126h can instruct the visual content monitoring engine 122t in the electronic device 102t and the video-conference status engine 124t in the network conferencing engine 120f to verify the incoming the visual content data and communicate the results back to the context engine 126g in the electronic device 102s to be communicated to the user. In some examples, a dedicated channel is used for the communication of the code or message to the electronic devices 102 and for the response.

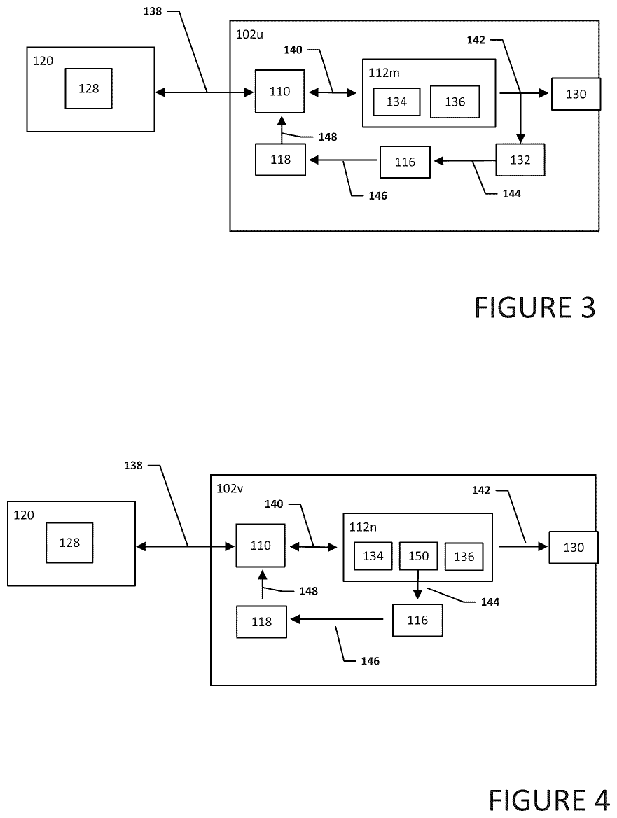

Turning to FIG. 3, FIG. 3 is a simple block diagram illustrating example details of a portion of a system configured to help allow for a conference call system with feedback, in accordance with an embodiment of the present disclosure. In an example, an electronic device 102u is part of a conference call system with feedback (e.g., the conference call system with feedback 100a illustrated in FIG. 1A). The electronic device 102u delivers analog audio data to the user listening to audio on the conference call.

As illustrated in FIG. 3, the electronic device 102u can include the communication engine 110, an analog audio system 112m, the audio monitoring engine 116, the audio-conference status engine 118, audio out device 130, and an analog to digital (A/D) converter 132. The audio out device 130 can be what communicates audio data to the user. For example, the audio out device 130 may be speakers, an audio jack for wired headphones, or some other end device or audio output device to communicate the audio data to the user. The analog audio system 112m can include an audio decoder 134 and audio out logic 136. The audio out logic 136 is based on user input and determines the audio out device (e.g., speaker, headset, etc.).

In an illustrative example, the communication engine 110 in the electronic device 102u receives conference call data 138 (that includes digital audio data) from the network conferencing engine 120. The communication engine 110 communicates the digital audio data 140 from the received conference call data 138 to the audio decoder 134 in the analog audio system 112m. The audio decoder 134 decodes the digital audio data 140, the audio out logic 136 determines an analog audio output 142, and communicates the analog audio output 142 to the audio out 130 where the audio data can be communicated to the user (e.g., through speakers, headphones, etc.). The analog audio output 142 is also communicated to the A/D converter 132. The A/D converter 132 converts the analog audio output 142 to digital audio output 144 and communicates the digital audio output 144 to the audio monitoring engine 116. The reason the analog audio output 142 is converted back to digital audio data and communicated to the audio monitoring engine 116 instead of just using the digital audio data 140 from the communication engine 110 is because the analog audio output 142 is the last audio signal that is used to covey the audio data to the user. The audio monitoring engine 116 samples the audio data and the result of the sampled audio data 146 is communicated to the audio-conference status engine 118. The audio-conference status engine 118 determines the quality and strength of the incoming audio data and communicates the determined quality and strength of audio 148 to the communication engine 110. The determined quality and strength of audio 148 can be determined using the audio volume threshold and the lost-sample threshold. The communication engine 110 communicates the determined quality and strength of audio 148 to the feedback engine 128 in the network conferencing engine 120. In some examples, the communications between the communication engine 110 and the audio-conference status engine 118 can be on a dedicated path.

In some examples, the audio-conference status engine 118 communicates the determined quality and strength of audio 148 to the feedback engine 128 in the network conferencing engine 120. For example, the audio-conference status engine 118 can communicate the determined quality and strength of audio 148 to the feedback engine 128 on a dedicated path. In other examples, the audio-conference status engine 118 is located in the network conferencing engine 120 (e.g., as illustrated in FIGS. 1C and 2B) and the audio monitoring engine 116 communicates the sampled audio data 146 to the audio-conference status engine 118 located in the network conferencing engine 120. In some examples, the communications between the feedback engine 128 and the audio-conference status engine 118 can be on a dedicated path.

Turning to FIG. 4, FIG. 4 is a simple block diagram illustrating example details of a portion of a system configured to help allow for a conference call system with feedback, in accordance with an embodiment of the present disclosure. In an example, an electronic device 102v is part of a conference call system with feedback (e.g., the conference call system with feedback 100a illustrated in FIG. 1A). The electronic device 102v delivers digital audio data to the user listening to audio on the conference call.

As illustrated in FIG. 4, the electronic device 102u can include the communication engine 110, an audio system 112n, the audio monitoring engine 116, the audio-conference status engine 118, and the audio out 130. The audio system 112n can include the audio decoder 134, the audio out logic 136, and an audio buffer 150.

In an illustrative example, the communication engine 110 in the electronic device 102u receives conference call data 138 (that includes digital audio data) from the network conferencing engine 120. The communication engine 110 communicates the digital audio data 140 from the received conference call data 138 to the audio decoder 134 in the audio system 112n, the audio decoder decodes the digital audio data 140. If the audio out device 130 is a digital device like (e.g., Bluetooth device or some other wireless device), then the audio out logic 136 inserts the digital audio data 140 in the audio buffer 150. The audio out logic 136 determines an audio output 142 and communicates the digital audio data 140 in the audio buffer 150 to the audio out 130 as audio output 142 where the audio data can be communicated to the user (e.g., Bluetooth, etc.). The digital audio data 140 in the audio buffer 150 is also communicated as digital audio output 144 to the audio monitoring engine 116. The reason the digital audio output 144 communicated to the audio monitoring engine 116 from the audio buffer 150 instead of just using the digital audio data 140 from the communication engine 110 is because the digital audio output 144 is the last audio signal that is used to covey the audio data to the user. The audio monitoring engine 116 digitally measures the audio data and the sampled audio data 146 is communicated to the audio-conference status engine 118. The audio-conference status engine 118 determines the quality and strength of the incoming audio data and communicates the determined quality and strength of audio 148 to the communication engine 110. The determined quality and strength of audio 148 can be determined using the audio volume threshold and the lost-sample threshold. The communication engine 110 communicates the determined quality and strength of audio 148 to the feedback engine 128 in the network conferencing engine 120. Such communications between the communication engine 110 and the audio-conference status engine 118 can be on a dedicated path.

In some examples, the audio-conference status engine 118 communicates determined quality and strength of audio 148 to the feedback engine 128 in the network conferencing engine 120. For example, the audio-conference status engine 118 can communicate the determined quality and strength of audio 148 to the feedback engine 128 on a dedicated path. In other examples, the audio-conference status engine 118 is located in the network conferencing engine 120 (e.g., as illustrated in FIGS. 1C and 2B) and the audio monitoring engine 116 communicates the sampled audio data 146 to the audio-conference status engine 118 located in the network conferencing engine 120. Such communications between 128 and 118 can be on a dedicated path.

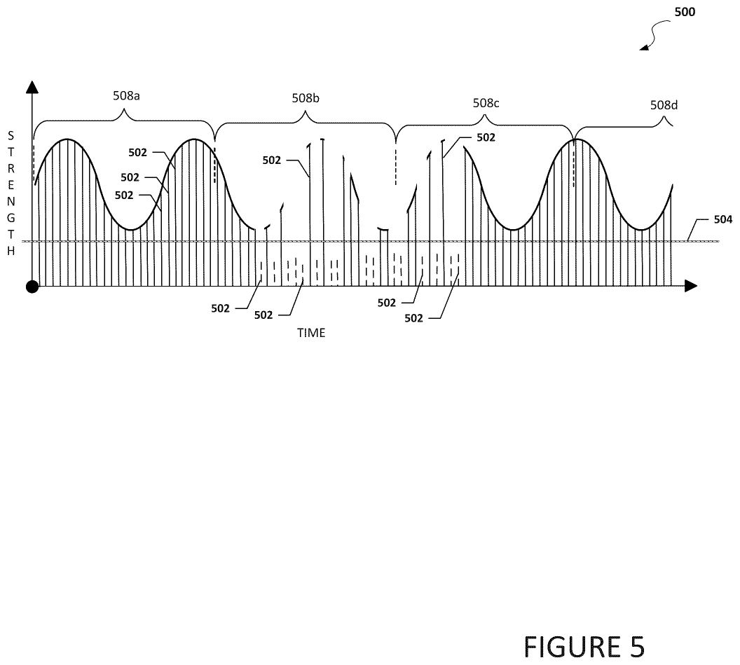

Turning to FIG. 5, FIG. 5 is a simple graph illustrating example details to help allow for a conference call system with feedback, in accordance with an embodiment of the present disclosure. As illustrated in FIG. 5, graph 500 illustrates example details of the quality and strength of example audio data during a conference call to help determine intermittent voice, static, or a problem with the audio. As illustrated in FIG. 5, the graph 500 can include samples of audio data 502 taken during a conference call. Also shown in FIG. 5 is a representation of the audio volume threshold 504, described below. In an example, the audio is transmitted at fifty (50) frames per second. The sampling frequency is in line to the display system of the receiver end and not to the sending end. The incoming audio is monitored at the same frequency as the display (e.g., 60 hz). If the strength (e.g., decibel level) of a sample of audio data 502 is below the audio volume threshold 504, a blank space is used to represent a gap in the audio. Note that in FIG. 5, the samples of audio data 502 that are below the audio volume threshold 504 are represented as dashed lines.

The audio volume threshold can be a fixed value that is determined initially at the starting of the call or can be updated periodically (e.g., every two (2) minutes, five (5) minutes, ten (10) minutes, etc., depending on design choice and design constraints). In some examples, a mean value of an audio decibel level is obtained and used as the audio volume threshold 504. The mean value of the audio decibel level is obtained by taking a percentage of an average of the decibel level over a time period (e.g., thirty percent (30%) of the average decibel level for the past two (2) to about three (3) minutes, depending on design choice and/or design constraints).

During a conference call, if the audio volume is lower than the audio volume threshold 504 for a predetermined amount of time (e.g., for about two (2) to about three (3) seconds or some other predetermined amount of time depending on design choice and/or design constraints), a low audio volume feedback can be reported by an audio conference status engine (e.g., the audio-conference status engine 118). More specially, if the audio volume that is being sampled at a sampling interval is less than the audio volume threshold, then the sampling interval is a lost-sample and the total number of lost samples during a predetermined time period is compared to the lost-sample threshold value. If the total number of lost samples during the predetermined time period is equal to or above the lost-sample threshold value, the audio conference status engine can report lost or jittery audio.

More specifically, as illustrated in FIG. 5, graph 500 includes three sampling interval 508a-508c and one partial sampling interval 508d. In the first sampling interval 508a, none of the samples of audio data 502 are below the audio volume threshold 504. In the second sampling interval 508b, several of the samples of audio data 502 are below the audio volume threshold 504 (shown as dashed lines). Also, in the third sampling interval 508c, some of the samples of audio data 502 that are below the audio volume threshold 504 (shown as dashed lines).

In a specific example, each of the sampling intervals 508a-508d can be a one second duration of audio is transmitted as a sequence of fifty (50) frames. Each frame can contain twenty (20) ms that is 1/50th of a second of speech content. If twenty-five (25) samples are lost-sample in fifty (50) frames (one second duration) and this happens for about two (2) to about three (3) seconds and in the third (3) frame there is a decrease in lost-sample count, the audio conference status engine can report lost or jittery audio. In this example it is considered that twenty-five (25) samples of lost-samples count is the threshold of the lost-sample threshold value. However, if for about two (2) to about three (3) seconds, when the audio monitoring engine detects about ninety percent (90%) to about one-hundred percent (100%) of a lost-sample count, it can be considered as silence. In this scenario no feedback be sent by the audio conference status engine. Even if there is error in lost-sample count threshold, the network conference engine can determine if there is any audio from the presenter user and if the report of lost audio is due to silence or no audio data from the presenter user. This can help avoid sending false positive feedback to the presenter user regarding lost audio during periods of silence or no audio data from the presenter user. In this way, a different variant of feedback messages are possible by refining the thresholds of the audio volume threshold and the lost-sample threshold. Also, the network conference engine, can be configured to help inhibit false positive triggers being sent to the presenter due to the pause and talk pattern of the presenter. The audio volume threshold, will also ensure to address hissing or background noise in the environment, low volume but constant noise like fan, AC, filter noise caused by a microphone, etc.

The system, and more particularly, the network conference engine can be configured to determine when many participant users are reporting a loss of audio. In an example, the network conference engine can aggregate the reports of loss of audio and communicate an aggregated message to the electronic device associated with the presenter user indicating that many electronic devices associated with a participant user are reporting the loss of audio. In another example, the network conference engine can communicate a message to the electronic device associated with the presenter user for each electronic device associated with the participating user that is reporting the loss of audio. The feedbacks provided by the system are self-sufficient and do not include a relatively large payload of data as compared to the payload of audio and/or video data.

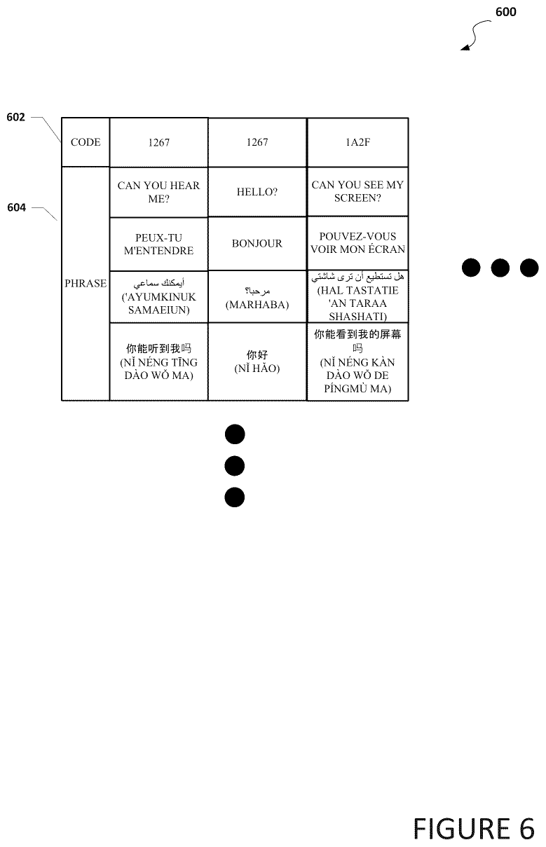

Turning to FIG. 6, FIG. 6 is a simple block diagram illustrating example details of a lookup table 600 to help allow for a conference call system with feedback, in accordance with an embodiment of the present disclosure. As illustrated in FIG. 6, the lookup table 600 can include words or phrases 604 and message or a code 602 that corresponds to each word or phrase. For example, the phrase “Can you hear me?” in English, French, Arabic, and Chinese corresponds to code “1267.” In addition, the phrase “Hello?” in English, French, Arabic, and Chinese also corresponds to code 1267 because the phase “Can you hear me?” and “hello?” can both be used by a presenter to determine if audio from the presenter is being communicated to the participants. In some examples, the presenter may be presenting visual content or video or sharing their screen and may inquire as to whether or not the participants can see the presenter's screen. The presenter may say “Can you see my screen?” and the phrase “Can you see my screen?” corresponds to code 1A2F.

In an illustrative example, during the conference call, a context engine (e.g., the context engine 126) can be used to detect pre-determined words or phrases spoken by a user (e.g., a presenter user), use lookup table 600 to determine a code associated with the pre-determined words or phrases, and the determined code can be communicated to other users (e.g., participant user) participating in the conference call. A content engine (e.g., the context engine 126) that receives the code 602 can use the lookup table 600 to interpret the code 602 and cause pre-designated tasks or queries to be performed or executed based on the determined code from the lookup table 600. In a specific example, the code is a hex code. It should be noted that lookup table 600 can include other phrases associated with a code and additional codes that are associated with different phrases. Additionally, when an electronic device (e.g., an electronic device associated with a participant user) receives the code 602, the code 602 acts as a trigger to the context engine to detect for a particular phrase for short period of time. By transmitting the hex code that acts a trigger to the context engine to cause pre-designated tasks or queries to be performed or executed, the compute over head can be reduced leading to power savings. Additionally, such hex code can also manage lexical language query and many such inter-operability issues.

Turning to FIG. 7, FIG. 7 is a simplified block diagram of a conference call system with feedback 100h, in accordance with an embodiment of the present disclosure. It should be noted that while the illustrative examples described below reference a single frame in a video stream, the illustrative example can be applied to each frame in the video stream or a sample of frames in the video stream (e.g., every 5th, 10th, 20th, 50th, etc. frame in the video steam). In an example, the conference call system with feedback 100h can include a plurality of electronic devices 102 in communication with each other using the network conferencing engine 120. More specifically, as illustrated in FIG. 7, the conference call system with feedback 100h can include electronic devices 102w and 102x in communication with each other using a network conferencing engine 120g. It should be noted that more electronic devices 102 can be included in the conference call system with feedback 100h.

Each of the electronic devices 102w and 102x can include the audio monitoring engine 116 (not shown), the audio-conference status engine 118 (not shown), the visual content monitoring engine 122, the video-conference status engine 124 (not shown), a context engine 126 (not shown), a display engine 152, a multiplexer/demultiplexer (mux/demuxer) 156, a timing controller (TCON) 158, and a display 160 (along with memory, one or more processors, a communication engine, audio system, display, etc.). The visual content monitoring engine 122 can include a screen signature engine 154. More specifically, as illustrated in FIG. 7, the electronic device 102w can include a visual content monitoring engine 122u, a display engine 152a, a mux/demuxer 156a, a TCON 158a, and a display 160a and the electronic device 102x can include a visual content monitoring engine 122x, a display engine 152b, a mux/demuxer 156b, a TCON 158b, and a display 160b. The visual content monitoring engine 122u can include a screen signature engine 154a. The visual content monitoring engine 122x can include a screen signature engine 154b. The network conferencing engine 120g can include the feedback engine 128.

The display engine 152a can be a processor, a core of a processor, part of a core of a processor, a dedicated graphics processor, a core of a graphics processor, part of a core of a graphics processor, a graphics engine, or source and located on a system on chip (SoC). The display engine 110a can be configured to help display an image on the display 160a. The TCON 158a can receive individual frames generated by the display engine 152a, correct for color and brightness, control the refresh rate of the display 160a, control the power savings of the display 160a, touch (if enabled), etc. The display engine 152b can be a processor, a core of a processor, part of a core of a processor, a dedicated graphics processor, a core of a graphics processor, part of a core of a graphics processor, a graphics engine, or source and located on a system on chip (SoC). The display engine 110b can be configured to help display an image on the display 160b. The TCON 158b can receive individual frames generated by the display engine 152b, correct for color and brightness, control the refresh rate of the display 160b, control the power savings of the display 160b, touch (if enabled), etc.

In an illustrative example, during a phase of a conference call, a user using the electronic device 102w can be showing visual information (e.g., an image, video, etc.) to a user using the electronic device 102x that is viewing the visual information. More specifically, the display engine 152a can create a frame of visual content 162 for display on display 160a and on display 160b. The frame of visual content 162 can be communicated to the visual content monitoring engine 122u, the mux/demuxer 156a, and the TCON 158a. The TCON 158a can process the frame of video visual 162 and communicate a processed frame 164 to the display 160a. The visual content monitoring engine 122u can use the screen signature engine 154a to create a screen signature 166 of the frame of visual content 162. In a specific example, the screen signature 166 is a vector, structural metric, or some other representation of the frame of visual content 162 or reference pixels in the frame of visual content 162 that can be used to verify visual content in the frame of visual content 162.

The visual content monitoring engine 122u can communicate the screen signature 166 of the frame of visual content 162 to the mux/demuxer 156a. The mux/demuxer 156a can receive the screen signature 166 of the frame of visual content 162 from the screen signature engine 154a in the visual content monitoring engine 122u and the frame of visual content 162 from the display engine 152a and combine the frame of visual content 162 and the screen signature 166. The frame of visual content 162 and the screen signature 166 can be communicated to the network conferencing engine 120g as illustrated by video conference communication 168. The video conference communication 168 can be communicated from the network conferencing engine 120g to the electronic devices 102 that are participating in the video conference.

More specifically, as illustrated in FIG. 7, the network conferencing engine 120g can communicate the video conference communication 168 to the electronic device 102x. The mux/demuxer 156b in the electronic device 102x can receive the video conference communication 168 and extract a received frame of visual content 170 and the screen signature 166. (Note that the received frame of visual content 170 should be the same or similar to the frame of visual content 162.) The mux/demuxer 156b can communicate the received frame of visual content 170 to the display engine 152b and can communicate the screen signature 166 to the visual content monitoring engine 122x. The display engine 152b can process the received frame of visual content 170 for display on display 160b and communicate the received frame 172 to the TCON 158b. The TCON 158b can process the received frame 172 and communicate a processed received frame 174 to the display 160b for display to the participating user.

The visual content monitoring engine 122x can received the screen signature 166 from the mux/demuxer 156b and the received frame 172 from the display engine 152b. The visual content monitoring engine 122x can use the screen signature engine 154a to compare the received frame 172 to the screen signature 166 and verify that the received frame 172 has the same visual content as the frame of visual content 162 from the electronic device 102w. The visual content monitoring engine 122x can communicate the determined verification 176 of the frame of visual content 162 from the electronic device 102w to the feedback engine 128 in the network conferencing engine 120g. The feedback engine 128 can communicate the result of the verification of visual information to the user of the electronic device 102q that is presenting the visual information. In some examples, the visual content monitoring engine 122x only communicates the determined verification 176 of the frame of visual content 162 if the verification fails (e.g., the screen signature 166 does not match and the received frame 172 does not have the same visual content as the frame of visual content 162 from the electronic device 102w). In some examples, the visual content monitoring engine 122x can communicate the determined verification 176 of the frame of visual content 162 to a visual content monitoring engine (e.g., the visual content monitoring engine 122. In some examples, a dedicated channel is used for the communication of the determined verification 176. During another phase of the conference call, the user using the electronic device 102x can be showing visual information (e.g., an image, video, etc.) to the user using the electronic device 102w and the processes described above is reversed.

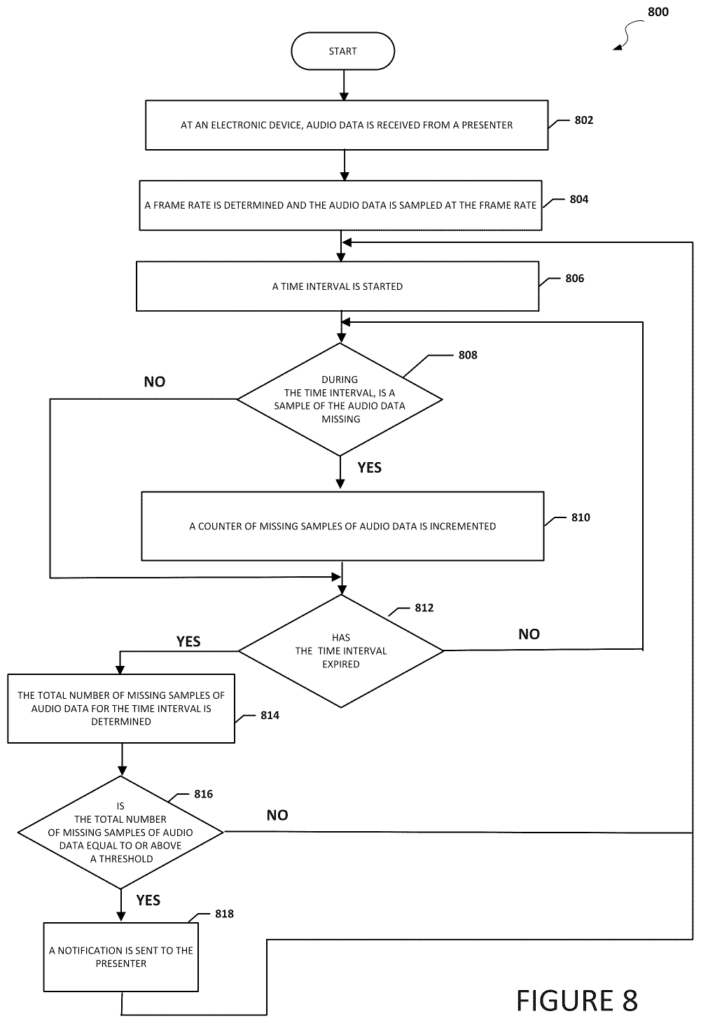

Turning to FIG. 8, FIG. 8 is an example flowchart illustrating possible operations of a flow 800 that may be associated with a conference call system with feedback, in accordance with an embodiment. In an embodiment, one or more operations of flow 800 may be performed by the audio monitoring engine 116, the audio-conference status engine 118, the network conferencing engine 120, the visual content monitoring engine 122, and the video-conference status engine 124. At 802, at an electronic device, audio data is received from a presenter. At 804, a frame rate is determined and the audio data is sampled at the frame rate. In an example, the frame rate is the frame rate of a display for the electronic device. At 806, a time interval is started. At 808, the system determines if during the time interval, a sample of the audio data is missing. For example, the system can determine if audio data is missing by comparing the audio data to a signature of the audio data for the time interval, determining if a portion of the audio data is below a decibel level, is below an audio volume threshold, is below about thirty percent (30%) of an average volume level, or some other means that can be used to determine if a sample of the audio data is missing. If the system determines a sample of the audio data is missing, a counter of missing samples of audio data is incremented, as in 810. At 812, the system determines if the time interval as expired. If the system determines a sample of the audio data is not missing, then the system determines if the time interval as expired, as in 812.

If the time interval as not expired, then the system returns to 808 and again, the system determines if during the time interval, a sample of the audio data is missing. If the time interval has expired, then the total number of missing samples of audio data for the time interval is determined, as in 814. At 816, the system determines if the total number of missing samples of audio data is equal to or above a threshold. If the total number of missing samples of audio data is equal to or above a threshold, a notification is sent to the presenter to notify the presenter about missing audio data or jittery audio, as in 818 and a (new) time interval is started, as in 806. If the total number of missing samples of audio data is not equal to or above a threshold, then a (new) time interval is started, as in 806. In some examples, a notification is also sent to the presenter if the total number of missing samples of audio data is not equal to or above a threshold to indicate the audio data was received. Note that for each new time interval, the counter of missing samples of audio data can be reset. In some examples, when the audio monitoring engine detects about ninety percent (90%) to about one-hundred percent (100%) of a lost-sample count for about two (2) to about three (3) seconds, it can be considered as silence and a notification is not sent to the presenter.

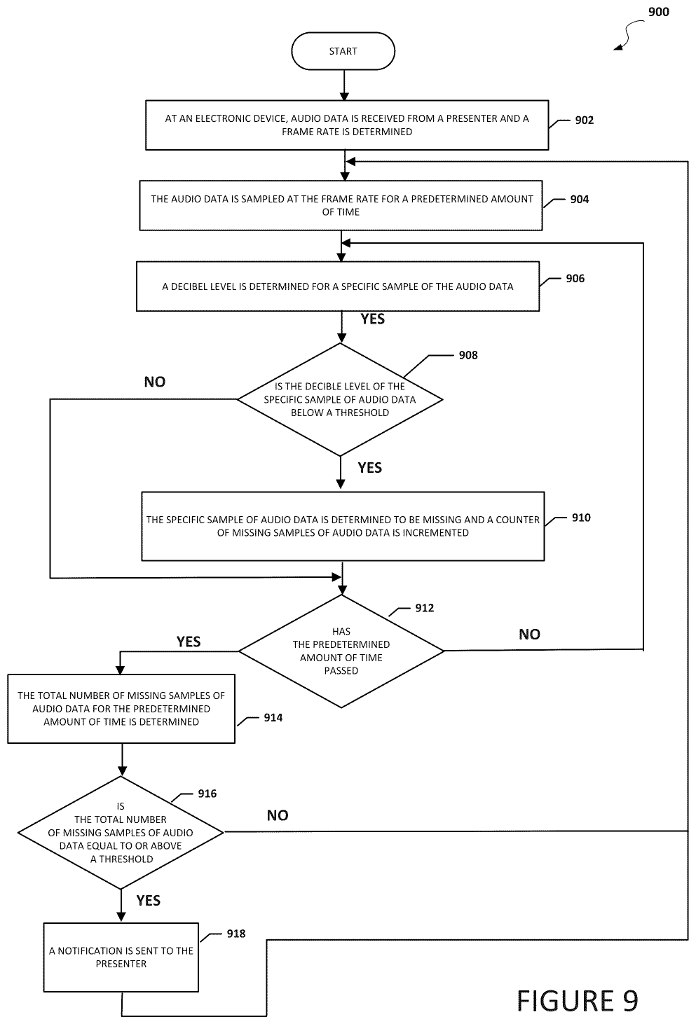

Turning to FIG. 9, FIG. 9 is an example flowchart illustrating possible operations of a flow 900 that may be associated with a conference call system with feedback, in accordance with an embodiment. In an embodiment, one or more operations of flow 900 may be performed by the audio monitoring engine 116, the audio-conference status engine 118, the network conferencing engine 120, the visual content monitoring engine 122, and the video-conference status engine 124. At 902, at an electronic device, audio data is received from a presenter and a frame rate is determined. In an example, the frame rate is the frame rate of a display for the electronic device. At 904, the audio data is sampled at the frame rate for a predetermined amount of time. At 906, a decibel level is determined for a specific sample of the audio data. At 908, the system determines if the decibel level of the specific sample of audio data is below a threshold. If the decibel level of the specific sample of audio data is below a threshold, the specific sample of audio data is determined to be missing or lost and a counter of lost samples of audio data is incremented, as in 910 and at 912, the system determines if the predetermined amount of time has passed. If the decibel level of the specific sample of audio data is not below a threshold, the system determines if the predetermined amount of time has passed, as in 912.

If a predetermined amount of time has not passed, then the system returns to 906, and a decibel level is determined for a specific sample of the audio data. If a predetermined amount of time has passed, then the total number of missing samples of audio data for the predetermined amount of time is determined, as in 914. At 916, the system determines if the total number of missing samples of audio data is equal to or above a threshold. If the total number of missing samples of audio data is equal to or above a threshold, a notification is sent to the presenter to notify the presenter about missing audio data or jittery audio, as in 918 and the audio data is sampled at the frame rate for a (new) predetermined amount of time, as in 904. If the total number of missing samples of audio data is not equal to or above a threshold, the audio data is sampled at the frame rate for a (new) predetermined amount of time, as in 904. In some examples, a notification is also sent to the presenter if the decibel level is at or above the threshold to indicate the audio data was received. Note that for each new predetermined amount of time, the counter of missing samples of audio data can be reset. In some examples, when the audio monitoring engine detects about ninety percent (90%) to about one-hundred percent (100%) of a lost-sample count for about two (2) to about three (3) seconds, it can be considered as silence and a notification is not sent to the presenter.

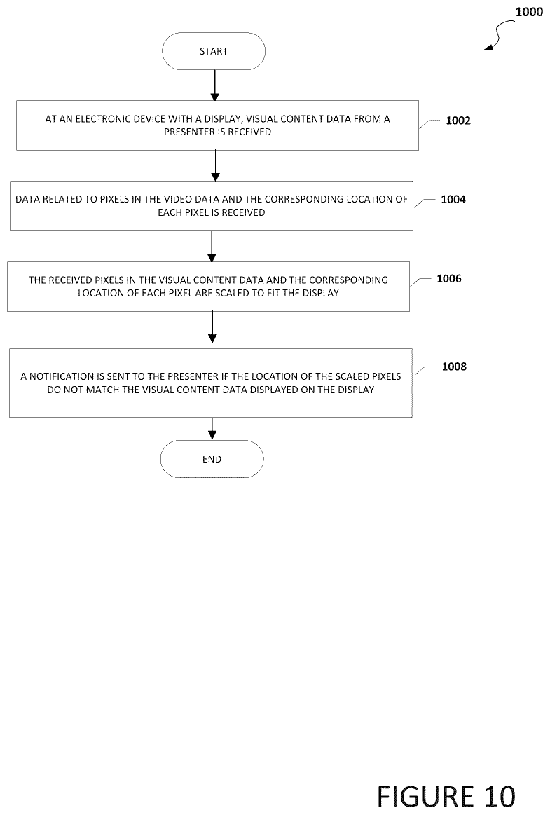

Turning to FIG. 10, FIG. 10 is an example flowchart illustrating possible operations of a flow 1000 that may be associated with a conference call system with feedback, in accordance with an embodiment. In an embodiment, one or more operations of flow 1000 may be performed by the audio monitoring engine 116, the audio-conference status engine 118, the network conferencing engine 120, the visual content monitoring engine 122, and the video-conference status engine 124. At 1002, at an electronic device with a display, visual content data from a presenter is received. At 1004, data related to pixels in the video data and the corresponding location of each pixel is received. At 1006, the received pixels in the visual content data and the corresponding location of each pixel are scaled to fit the display. At 1008, a notification (e.g., a missing visual content notification) is sent to the presenter if the location of the scaled pixels does not match the visual content data displayed on the display to indicate that the visual content was not received. In some examples, a notification is also sent to the presenter if the location of the scaled pixels matches the visual content data displayed on the display to indicate the visual content was received.

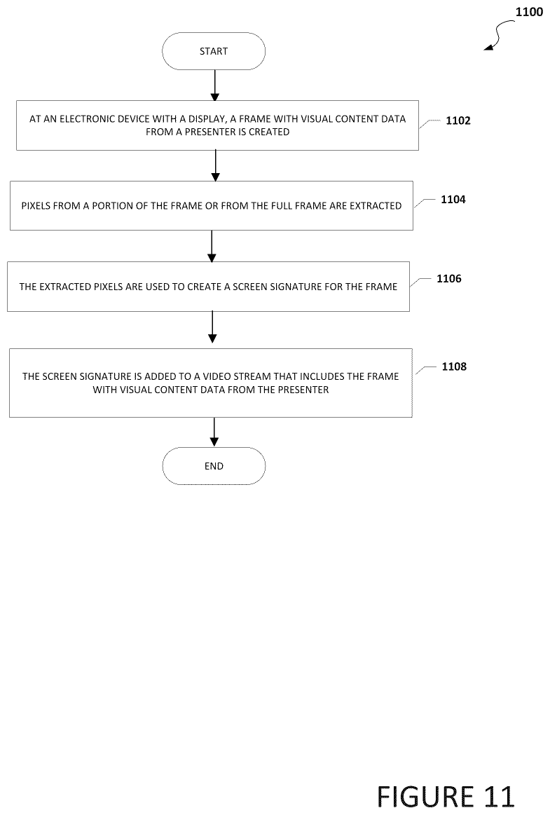

Turning to FIG. 11, FIG. 11 is an example flowchart illustrating possible operations of a flow 1100 that may be associated with a conference call system with feedback, in accordance with an embodiment. In an embodiment, one or more operations of flow 1100 may be performed by the audio monitoring engine 116, the audio-conference status engine 118, the network conferencing engine 120, the visual content monitoring engine 122, and the video-conference status engine 124. At 1102, at an electronic device with a display, a frame with visual content data from a presenter is created. At 1104, pixels from a portion of the frame or from the full frame are extracted. At 1106, the extracted pixels are used to create a screen signature for the frame. For example, the screen signature engine 154a shown in FIG. 7 can use the extracted pixels to create a screen signature for the frame. At 1108, the screen signature is added to a video stream that includes the frame with visual content data from the presenter.

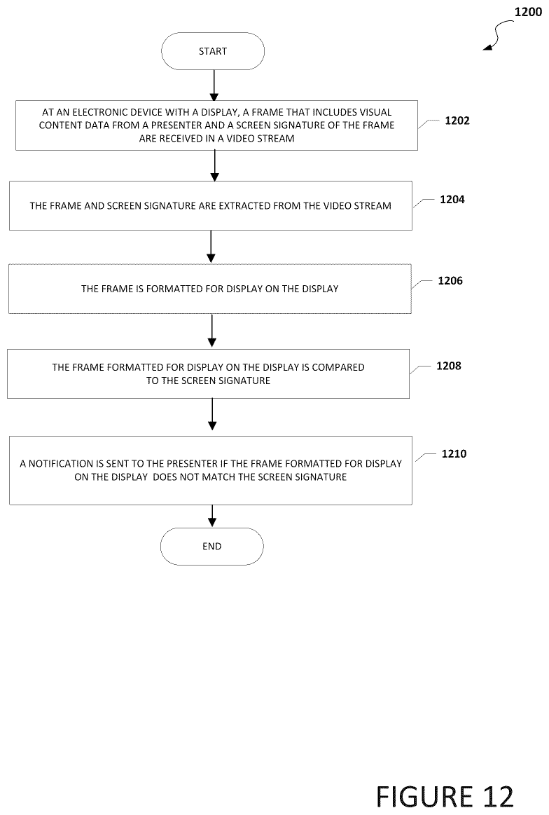

Turning to FIG. 12, FIG. 12 is an example flowchart illustrating possible operations of a flow 1200 that may be associated with a conference call system with feedback, in accordance with an embodiment. In an embodiment, one or more operations of flow 1200 may be performed by the audio monitoring engine 116, the audio-conference status engine 118, the network conferencing engine 120, the visual content monitoring engine 122, and the video-conference status engine 124. At 1202, at an electronic device with a display, a frame that includes visual content data from a presenter and a screen signature of the frame are received in a video stream. At 1204, the frame and screen signature are extracted from the video stream. At 1206, the frame is formatted for display on the display. For example, the frame can be formatted for display on the display by the display engine 152b shown in FIG. 7. At 1208, the frame formatted for display on the display is compared to the screen signature. For example, the screen signature engine 154b shown in FIG. 7can compare the frame formatted for display on the display to the screen signature. At 1210, a notification is sent to the presenter if the frame formatted for display on the display does not match the screen signature. In some examples, a notification is sent to the presenter if the frame formatted for display on the display does match the screen signature (e.g., a green light or check mark icon to indicate the frame received by the electronic device matches the screen signature).

In an example implementation, the electronic devices 102a-102x are meant to encompass a computer, a personal digital assistant (PDA), a laptop or electronic notebook, hand held device, a cellular telephone, a smartphone, an IP phone, wearables, or any other device, component, element, or object that can participate in the conference call. Each of electronic devices 102a-102x may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information. Each of the electronic devices 102a-102x may include virtual elements.

In regards to the internal structure, each of the electronic devices 102a-102x can include memory elements for storing information to be used in operations. Each of the electronic devices 102a-102x may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received could be provided in any database, register, queue, table, cache, control list, or other storage structure, all of which can be referenced at any suitable timeframe. Any such storage options may also be included within the broad term ‘memory element’ as used herein.

In certain example implementations, functions may be implemented by logic encoded in one or more tangible media (e.g., embedded logic provided in an ASIC, digital signal processor (DSP) instructions, integrated sensor-hub, encoders, decoders, software (potentially inclusive of object code and source code) to be executed by a processor, or other similar machine, etc.), which may be inclusive of non-transitory computer-readable media. In some of these instances, memory elements can store data used for operations. This includes the memory elements being able to store software, logic, code, or processor instructions that are executed to carry out operations or activities.

In an example implementation, elements of the electronic devices 102a-102x may include software modules (e.g., the audio monitoring engine 116, the audio-conference status engine 118, the network conferencing engine 120, the visual content monitoring engine 122, and the video-conference status engine 124, context engine 126, etc.) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of the electronic devices 102a-102x can include one or more processors that can execute software or an algorithm. In one example, the processors could transform an element or an article (e.g., data) from one state or thing to another state or thing. In another example, activities may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read-only memory (EPROM), an electrically erasable programmable read-only memory (EEPROM)) or an ASIC that includes digital logic, software, code, electronic instructions, or any suitable combination thereof. Any of the potential processing elements, modules, and machines described herein should be construed as being encompassed within the broad term ‘processor.’

Implementations of the embodiments disclosed herein may be formed or carried out on or over a substrate, such as a non-semiconductor substrate or a semiconductor substrate. In one implementation, the non-semiconductor substrate may be silicon dioxide, an inter-layer dielectric composed of silicon dioxide, silicon nitride, titanium oxide and other transition metal oxides. Although a few examples of materials from which the non-semiconducting substrate may be formed are described here, any material that may serve as a foundation upon which a non-semiconductor device may be built falls within the spirit and scope of the embodiments disclosed herein.

In another implementation, the semiconductor substrate may be a crystalline substrate formed using a bulk silicon or a silicon-on-insulator substructure. In other implementations, the semiconductor substrate may be formed using alternate materials, which may or may not be combined with silicon, that include but are not limited to germanium, indium antimonide, lead telluride, indium arsenide, indium phosphide, gallium arsenide, indium gallium arsenide, gallium antimonide, or other combinations of group III-V or group IV materials. In other examples, the substrate may be a flexible substrate including 2D materials such as graphene and molybdenum disulphide, organic materials such as pentacene, transparent oxides such as indium gallium zinc oxide poly/amorphous (low temperature of dep) III-V semiconductors and germanium/silicon, and other non-silicon flexible substrates. Although a few examples of materials from which the substrate may be formed are described here, any material that may serve as a foundation upon which a semiconductor device may be built falls within the spirit and scope of the embodiments disclosed herein.

It is also important to note that the operations in the preceding diagrams illustrates only some of the possible scenarios and patterns that may be executed by, or within, the electronic devices 102a-102x. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by the electronic devices 102a-102x in that any suitable arrangements, chronologies, configurations, and timing mechanisms may be provided without departing from the teachings of the present disclosure.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the electronic devices 102a-102x and their teachings are readily scalable and can accommodate a large number of components, as well as more complicated/sophisticated arrangements and configurations. Accordingly, the examples provided should not limit the scope or inhibit the broad teachings of the electronic devices 102a-102x and as potentially applied to a myriad of other architectures.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the electronic devices 102a-102x have been illustrated with reference to particular elements and operations, these elements and operations may be replaced by any suitable architecture, protocols, and/or processes that achieve the intended functionality of the electronic devices 102a-102x.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example M1 is a method including receiving audio data at an electronic device, from a network conference engine, sampling the audio data at a frame rate, determining an amount of missing samples of audio data for a predetermined amount of time, and communicating, to the network conference engine, a notification when the amount of missing samples of audio data for the predetermined amount of time is greater than a lost sample threshold.

In Example M2, the subject matter of Example M1 can optionally include where a specific sample of audio data is missing when the specific sample of audio data has a decibel level below an audio volume threshold.

In Example M3, the subject matter of Example M1 can optionally include where the audio volume threshold is at least partially based on a percentage of an average decibel level of previously received audio data.

In Example M4, the subject matter of Example M1 can optionally include where the electronic device includes a display and the received audio data is sampled at a frame rate of the display.

In Example M5, the subject matter of Example M1 can optionally include receiving visual content from the network conference engine, receiving visual content verification data from the network conference engine that can be used to verify the received visual content, using the visual content verification data to determine if visual content to be rendered on a display of the electronic device is the same or similar to the received visual content from the network conference engine, and communicating, to the network conference engine, a missing visual content notification when the visual content to be rendered on the display is not the same or similar to the received visual content from the network conference engine.

In Example, M6, the subject matter of Example M1 can optionally include where the visual content verification data includes specific reference pixels and pixels of the visual content to be rendered on the display are compared with the reference pixels in the visual content verification data to determine if the visual content to be rendered on the display is the same visual content from the network conference engine.

In Example M7, the subject matter of any of the Examples M1-M2 can optionally include where the audio volume threshold is at least partially based on a percentage of an average decibel level of previously received audio data.

In Example M8, the subject matter of any of the Examples M1-M3 can optionally include where the electronic device includes a display and the received audio data is sampled at a frame rate of the display.

In Example M9, the subject matter of any of the Examples M1-M4 can optionally include receiving visual content from the network conference engine, receiving visual content verification data from the network conference engine that can be used to verify the received visual content, using the visual content verification data to determine if visual content to be rendered on a display of the electronic device is the same or similar to the received visual content from the network conference engine, and communicating, to the network conference engine, a missing visual content notification when the visual content to be rendered on the display is not the same or similar to the received visual content from the network conference engine.

In Example, M10, the subject matter of any of the Examples M1-M5 can optionally include where the visual content verification data includes specific reference pixels and pixels of the visual content to be rendered on the display are compared with the reference pixels in the visual content verification data to determine if the visual content to be rendered on the display is the same visual content from the network conference engine.

In Example A1, an electronic device can include an audio monitoring engine that receives audio data related to a conference call from a network conference engine, where the audio monitoring engine determines if at least a portion of the audio data is below an audio volume threshold and an audio-conference status engine that communicates a message to the network conference engine when at least a portion of the audio data is below the audio volume threshold.

In Example A2, the subject matter of Example A1 can optionally include where the audio volume threshold is at least partially based on a percentage of an average decibel level of previously received audio data.

In Example A3, the subject matter of Example A1 can optionally include the received audio data is sampled at a frame rate.

In Example A4, the subject matter of Example A3 can optionally include a display, where the frame rate is a frame rate of the display.

In Example A5, the subject matter of Example A3 can optionally include where a decibel level of each of the sampled received audio data is compared to the audio volume threshold and if the decibel level of a specific sample of received audio data is below the audio volume threshold, the specific sample of received audio data is considered missing.

In Example A6, the subject matter of Example A1 can optionally include where the message is communicated to a network conferencing engine when a total number of missing samples of audio data is equal to or greater than a lost sample threshold.

In Example A7, the subject matter of Example A1 can optionally include where an audio decoder and audio out logic, where the received audio data is converted to analog audio data and the audio data is sampled after the analog audio data has been processed by the audio out logic.

In Example A8, the subject matter of Example A1 can optionally include where an audio decoder and audio out logic, where the audio data is digital audio data and the audio data is sampled after the audio data has been processed by the audio decoder and before the audio data has been processed by the audio out logic.

In Example A9, the subject matter of Example A1 can optionally include a display and a visual content monitoring engine, where the visual content monitoring engine receives visual content verification data that can be used to verify received visual content related to the conference call.

In Example A10, the subject matter of Example A1 can optionally include where the visual content verification data includes specific reference pixels, where the visual content monitoring engine compares pixels of visual content to be rendered on the display with the reference pixels in the visual content verification data to determine if the visual content to be rendered on the display is the same or similar to the received visual content related to the conference call.

In Example A11, the subject matter of Example A1 can optionally include a context engine to convert a phrase spoken by a user to a code, where the code is used to initiate a determination that indicates if any audio data is missing and/or is below an audio volume threshold or a determination that verifies visual content of received data.

In Example A12, the subject matter of any of Examples A1-A2 can optionally include where the received audio data is sampled at a frame rate.

In Example A13, the subject matter of any of Examples A1-A3 can optionally include a display, where the frame rate is a frame rate of the display.

In Example A14, the subject matter of any of Examples A1-A4 can optionally include where a decibel level of each of the sampled received audio data is compared to the audio volume threshold and if the decibel level of a specific sample of received audio data is below the audio volume threshold, the specific sample of received audio data is considered missing.

In Example A12, the subject matter of any of Examples A1-A5 can optionally include where the message is communicated to a network conferencing engine when a total number of missing samples of audio data is equal to or greater than a lost sample threshold.

In Example A13, the subject matter of any of Examples A1-A6 can optionally include an audio decoder and audio out logic, where the received audio data is converted to analog audio data and the audio data is sampled after the analog audio data has been processed by the audio out logic.

In Example A14, the subject matter of any of Examples A1-A7 can optionally include an audio decoder and audio out logic, where the audio data is digital audio data and the audio data is sampled after the audio data has been processed by the audio decoder and before the audio data has been processed by the audio out logic.

In Example A15, the subject matter of any of Examples A1-A8 can optionally include a display and a visual content monitoring engine, where the visual content monitoring engine receives visual content verification data that can be used to verify received visual content related to the conference call.

In Example A16, the subject matter of any of Examples A1-A9 can optionally include where the visual content verification data includes specific reference pixels, where the visual content monitoring engine compares pixels of visual content to be rendered on the display with the reference pixels in the visual content verification data to determine if the visual content to be rendered on the display is the same or similar to the received visual content related to the conference call.

In Example A17, the subject matter of any of Examples A1-A10 can optionally include a context engine to convert a phrase spoken by a user to a code, where the code is used to initiate a determination that indicates if any audio data is missing and/or is below an audio volume threshold or a determination that verifies visual content of received data.

Example S1 is a network conference call system including a receiving electronic device in communication with a transmitting electronic device using a network conferencing engine, an audio monitoring engine in the receiving electronic device that receives audio data from the transmitting electronic device, and an audio conference status engine that communicates a message to the network conferencing engine, the message including a determination of whether or not any audio data received by the receiving electronic device is missing and/or is below an audio volume threshold.

In Example S2, the subject matter of Example S1 can optionally include where the message is communicated to the network conferencing engine when a total number of missing samples of audio data and/or a total number of samples of audio data below the audio volume threshold is equal to or greater than a lost sample threshold.

In Example S3, the subject matter of Example S1 can optionally include a visual content monitoring engine in the receiving electronic device to verify visual content received from the transmitting electronic device.

In Example S4, the subject matter of any of Examples S1-S2 can optionally include a visual content monitoring engine in the receiving electronic device to verify visual content received from the transmitting electronic device.

Example SS1 is a system including means for receiving audio data at an electronic device, from a network conference engine, means for sampling the audio data at a frame rate, means for determining an amount of missing samples of audio data for a predetermined amount of time, and means for communicating, to the network conference engine, a notification when the amount of missing samples of audio data for the predetermined amount of time is greater than a lost sample threshold.

In Example SS2, the subject matter of Example SS1 can optionally include where a specific sample of audio data is missing when the specific sample of audio data has a decibel level below an audio volume threshold.

In Example SS3, the subject matter of Example SS1 can optionally include where the audio volume threshold is at least partially based on a percentage of an average decibel level of previously received audio data.

In Example SS4, the subject matter of Example SS1 can optionally include where the electronic device includes a display and the received audio data is sampled at a frame rate of the display.

In Example SS5, the subject matter of Example SS1 can optionally include means for receiving visual content from the network conference engine, means for receiving visual content verification data from the network conference engine that can be used to verify the received visual content, means for using the visual content verification data to determine if visual content to be rendered on a display of the electronic device is the same or similar to the received visual content from the network conference engine, and means for communicating, to the network conference engine, a missing visual content notification when the visual content to be rendered on the display is not the same or similar to the received visual content from the network conference engine.

In Example SS6, the subject matter of Example SS1 can optionally include where the visual content verification data includes specific reference pixels and pixels of the visual content to be rendered on the display are compared with the reference pixels in the visual content verification data to determine if the visual content to be rendered on the display is the same visual content from the network conference engine.

In Example SS7, the subject matter of any of the Examples SS1-SS2 can optionally include where the audio volume threshold is at least partially based on a percentage of an average decibel level of previously received audio data.

In Example SS8, the subject matter of any of the Examples SS1-SS3 can optionally include where the electronic device includes a display and the received audio data is sampled at a frame rate of the display.

In Example SS9, the subject matter of any of the Examples SS1-SS4 can optionally include means for receiving visual content from the network conference engine, means for receiving visual content verification data from the network conference engine that can be used to verify the received visual content, means for using the visual content verification data to determine if visual content to be rendered on a display of the electronic device is the same or similar to the received visual content from the network conference engine, and means for communicating, to the network conference engine, a missing visual content notification when the visual content to be rendered on the display is not the same or similar to the received visual content from the network conference engine.

In Example SS10, the subject matter of any of the Examples SS1-SS5 can optionally include where the visual content verification data includes specific reference pixels and pixels of the visual content to be rendered on the display are compared with the reference pixels in the visual content verification data to determine if the visual content to be rendered on the display is the same visual content from the network conference engine.

Example X1 is a machine-readable storage medium including machine-readable instructions to implement a method or realize an apparatus as in any one of the Examples M1-M6, S1-S4, or SS1-SS10. Example Y1 is an apparatus comprising means for performing any of the Example methods M1-M10. In Example Y2, the subject matter of Example Y1 can optionally include the means for performing the method comprising a processor and a memory. In Example Y3, the subject matter of Example Y2 can optionally include the memory comprising machine-readable instructions.

1.-20. (canceled)

21. A method comprising:
receiving audio data at an electronic device, from a network conference engine;
sampling the audio data at a frame rate;
determining an amount of missing samples of audio data for a predetermined amount of time; and
communicating, to the network conference engine, a notification when the amount of missing samples of audio data for the predetermined amount of time is greater than a lost sample threshold.

22. The method of claim 21, wherein a specific sample of audio data is missing when the specific sample of audio data has a decibel level below an audio volume threshold.

23. The method of claim 22, wherein the audio volume threshold is at least partially based on a percentage of an average decibel level of previously received audio data.

24. The method of claim 21, wherein the electronic device includes a display and the received audio data is sampled at a frame rate of the display.

25. The method of claim 21, further comprising:
receiving visual content from the network conference engine;
receiving visual content verification data from the network conference engine that can be used to verify the received visual content;
using the visual content verification data to determine if visual content to be rendered on a display of the electronic device is the same or similar to the received visual content from the network conference engine; and
communicating, to the network conference engine, a missing visual content notification when the visual content to be rendered on the display is not the same or similar to the received visual content from the network conference engine.

26. The method of claim 25, wherein the visual content verification data includes specific reference pixels and pixels of the visual content to be rendered on the display are compared with the reference pixels in the visual content verification data to determine if the visual content to be rendered on the display is the same visual content from the network conference engine.

27. An electronic device comprising:
an audio monitoring engine that receives audio data related to a conference call from a network conference engine, wherein the audio monitoring engine determines if at least a portion of the audio data is below an audio volume threshold; and
an audio-conference status engine that communicates a message to the network conference engine when at least a portion of the audio data is below the audio volume threshold.

28. The electronic device of claim 27, wherein the audio volume threshold is at least partially based on a percentage of an average decibel level of previously received audio data.

29. The electronic device of claim 27, wherein the received audio data is sampled at a frame rate.

30. The electronic device of claim 29, further comprising:
a display, wherein the frame rate is a frame rate of the display.

31. The electronic device of claim 29, wherein a decibel level of each of the sampled received audio data is compared to the audio volume threshold and if the decibel level of a specific sample of received audio data is below the audio volume threshold, the specific sample of received audio data is considered missing.

32. The electronic device of claim 27, wherein the message is communicated to a network conferencing engine when a total number of missing samples of audio data is equal to or greater than a lost sample threshold.

33. The electronic device of claim 27, further comprising:
an audio decoder; and
audio out logic, wherein the received audio data is converted to analog audio data and the audio data is sampled after the analog audio data has been processed by the audio out logic.

34. The electronic device of claim 27, further comprising:
an audio decoder; and
audio out logic, wherein the audio data is digital audio data and the audio data is sampled after the audio data has been processed by the audio decoder and before the audio data has been processed by the audio out logic.

35. The electronic device of claim 27, further comprising:
a display; and
a visual content monitoring engine, wherein the visual content monitoring engine receives visual content verification data that can be used to verify received visual content related to the conference call.

36. The electronic device of claim 35, wherein the visual content verification data includes specific reference pixels, wherein the visual content monitoring engine compares pixels of visual content to be rendered on the display with the reference pixels in the visual content verification data to determine if the visual content to be rendered on the display is the same or similar to the received visual content related to the conference call.

37. The electronic device of claim 27, further comprising:
a context engine to convert a phrase spoken by a user to a code, wherein the code is used to initiate a determination that indicates if any audio data is missing and/or is below an audio volume threshold or a determination that verifies visual content of received data.

38. A network conference call system comprising:
a receiving electronic device in communication with a transmitting electronic device using a network conferencing engine;
an audio monitoring engine in the receiving electronic device that receives audio data from the transmitting electronic device; and
an audio conference status engine that communicates a message to the network conferencing engine, the message including a determination of whether or not any audio data received by the receiving electronic device is missing and/or is below an audio volume threshold.

39. The network conference call system of claim 38, wherein the message is communicated to the network conferencing engine when a total number of missing samples of audio data and/or a total number of samples of audio data below the audio volume threshold is equal to or greater than a lost sample threshold.

40. The network conference call system of claim 38, further comprising:
a visual content monitoring engine in the receiving electronic device to verify visual content received from the transmitting electronic device.
